(19) United States
(12) Patent Application Publication
(10) Pub. No.: US 2025/0240737 A1
(43) Pub. Date: Jul. 24, 2025

(54) SIMULTANEOUS TRANSMISSION ON MULTI-PANEL IN WIRELESS NETWORKS

(71) Applicant: Samsung Electronics Co., Ltd., Suwon-si (KR)

(72) Inventors: Shiyang Leng, Allen, TX (US); Anil Agiwal, Allen, TX (US); Seungri Jin, Seoul (KR); Seongmok Lim, Seoul (KR)

(21) Appl. No.: 19/015,510

(22) Filed: Jan. 9, 2025

Related U.S. Application Data
(60) Provisional application No. 63/622,420, filed on Jan. 18, 2024.
(60) Provisional application No. 63/622,933, filed on Jan. 19, 2024.
(60) Provisional application No. 63/625,636, filed on Jan. 26, 2024.
(60) Provisional application No. 63/574,652, filed on Apr. 4, 2024.
(60) Provisional application No. 63/644,132, filed on May 8, 2024.
(60) Provisional application No. 63/644,810, filed on May 9, 2024.

(51) Int. Cl. H04W 52/36; H04W 72/1268

(52) U.S. Cl. CPC H04W 52/365; H04W 72/1268

(57) ABSTRACT

When a user equipment (UE) determines a power headroom reporting (PHR) is triggered and a transmitting MAC entity can accommodate a medium access control (MAC) control element (CE) for PHR, and if this MAC entity is configured with a two-PHR mode and any associated serving cell is configured with a multi-panel scheme, the UE instructs the multiplexing and assembly procedure to generate and transmit an enhanced multiple entry PHR for multiple transmit-receive point (TRP) simultaneous transmission with multi-panel (STxMP) MAC CE if multiple PHRs are configured. Otherwise, instruct the Multiplexing and Assembly procedure to generate and transmit the Enhanced Single Entry PHR for multiple TRP STx2P MAC CE.

### CROSS-REFERENCE TO RELATED APPLICATION(S)

This application claims the benefit of priority from U.S. Provisional Application No. 63/622,420 entitled “SIMULTANEOUS TRANSMISSION ON MULTI-PANEL DEVICE,” filed Jan. 18, 2024; U.S. Provisional Application No. 63/622,933 entitled “SIMULTANEOUS TRANSMISSION ON MULTI-PANEL DEVICE,” filed Jan. 19, 2024; U.S. Provisional Application No. 63/625,636 entitled “SIMULTANEOUS TRANSMISSION ON MULTI-PANEL DEVICE,” filed Jan. 26, 2024; U.S. Provisional Application No. 63/574,652 entitled “SIMULTANEOUS TRANSMISSION ON MULTI-PANEL DEVICE,” filed Apr. 4, 2024; U.S. Provisional Application No. 63/644,132 entitled “SIMULTANEOUS TRANSMISSION ON MULTI-PANEL DEVICE,” filed May 8, 2024; U.S. Provisional Application No. 63/644,810 entitled “POWER HEADROOM REPORTING MAC CE FOR SIMULTANEOUS TRANSMISSION ON MULTI-PANEL,” filed May 9, 2024, all of which are incorporated herein by reference in their entireties.

### TECHNICAL FIELD

This disclosure relates generally to a wireless communication system, and more particularly to, for example, but not limited to, simultaneous transmission on multi-panel in a wireless communication system.

### BACKGROUND

Mobility management operations including network handovers represent a pivotal aspect of any wireless communication system. These systems include, for example, LTE and 5G New Radio (NR), and upcoming technologies currently coined “6G”. Mobility is presently controlled by the network with user equipment (UE) assistance to maintain optimal connection quality. The network may hand over the UE to a target cell with superior signal quality.

The inclusion of enhanced broadband mechanisms requiring high speeds and low latencies has necessitated more sophisticated handover mechanisms. Accordingly, conditional handovers (CHOs) and separately, layer 1/layer 2 triggered mobility (LTM) have been introduced to provide additional conditions for specific networks or slices thereof to increase handover speed. The use of these enhancements, however, introduces latencies of its own, at least because the network needs to conduct several data exchanges with the UE during the handover process. The initiation of a prospective handover triggered by the network consequently introduces latencies, signaling overhead, and interruption times of its own.

The description set forth in the background section should not be assumed to be prior art merely because it is set forth in the background section. The background section may describe aspects or embodiments of the present disclosure.

### SUMMARY

An aspect of the disclosure provides a UE for facilitating communication in a wireless network. The UE comprises a processor is configured to; determine that a power headroom reporting (PHR) is triggered; determine that an allocated uplink resource is able to accommodate a medium access control (MAC) control element (CE) for the PHR; determine that the UE is configured with a two-PHR mode for a MAC entity and a serving cell associated with the MAC entity is configured with a multi-panel scheme; and generate an enhanced single entry PHR for multiple transmit-receive point (TRP) simultaneous transmission with multi-panel (STxMP) MAC CE or an enhanced multiple entry PHR for multiple TRP STxMP MAC CE. The UE comprises a transceiver operably coupled with the processor. The transceiver is configured to transmit, to a base station (BS), the enhanced single entry PHR for multiple TRP STxMP MAC CE or the enhanced multiple entry PHR for multiple TRP STxMP MAC CE.

In some embodiments, the processor is configured to generate the enhanced single entry PHR for multiple TRP STxMP MAC CE based on a determination that a single entry PHR is used.

In some embodiments, the processor is configured to generate the enhanced multiple entry PHR for multiple TRP STxMP MAC CE based on a determination that multiple PHRs are configured.

In some embodiments, the enhanced single entry PHR for multiple TRP STxMP MAC CE includes two sets of fields, each set including a power headroom (PH) field and a configured transmitted power field. The PH field indicates a type-1 power headroom level, and the configured transmitted power field indicates a configured maximum output power that is used for calculation of a preceding PH field. A first PH field in a first set of fields is associated with a first transmission configuration indicator (TCI) state for a first physical uplink shared channel (PUSCH) transmission, and a second PH field in a second set of fields is associated with a second TCI state for a second PUSCH transmission.

In some embodiments, each set further includes a field indicating whether a corresponding PH field is associated with a real PUSCH transmission or a reference PUSCH transmission.

In some embodiments, the enhanced multiple entry PHR for multiple TRP STxMP MAC CE includes two sets of fields for each reported serving cell that is configured with the multi-panel scheme, each set including a PH field and a configured transmitted power field. The PH field indicates a type-1 power headroom level and the configured transmitted power field indicates a configured maximum output power that is used for calculation of a preceding PH field. A first PH field in a first set of fields is associated with a first TCI state for a first PUSCH transmission, and a second PH field in a second set of fields is associated with a second TCI state for a second PUSCH transmission.

In some embodiments, each set further includes a field indicating whether a corresponding PH field is associated with a real PUSCH transmission or a reference PUSCH transmission.

In some embodiments, the each set further includes a maximum permissible exposure (MPE) information associated with a corresponding configured transmitted power field for the serving cell operating on frequency range 2 (FR 2).

In some embodiments, the processor is further configured, for the enhanced multiple entry PHR for multiple TRP STxMP MAC CE, to obtain two type-1 PH values for a corresponding uplink carrier for the serving cell. Each type-1 PH value indicates a difference between a nominal UE maximum transmit power and an estimated power for an uplink shared channel (UL-SCH) transmission.

In some embodiments, the processor is further configured, for the enhanced single entry PHR for multiple TRP STxMP MAC CE, to obtain two type-1 PH values and two configured transmitted power values for a corresponding uplink carrier for a primary cell. Each type-1 PH value indicates a difference between a nominal UE maximum transmit power and an estimated power for a UL-SCH transmission.

An aspect of the disclosure provides a method performed by a UE in a wireless network. The method comprises: determining that a power headroom reporting (PHR) is triggered; determining that an allocated uplink resource is able to accommodate a medium access control (MAC) control element (CE) for the PHR; determining that the UE is configured with a two-PHR mode for a MAC entity and a serving cell associated with the MAC entity is configured with a multi-panel scheme; generating an enhanced single entry PHR for multiple transmit-receive point (TRP) simultaneous transmission with multi-panel (STxMP) MAC CE or an enhanced multiple entry PHR for multiple TRP STxMP MAC CE; and transmitting, to a base station (BS), the enhanced single entry PHR for multiple TRP STxMP MAC CE or the enhanced multiple entry PHR for multiple TRP STxMP MAC CE.

In some embodiments, generating comprises generating the enhanced single entry PHR for multiple TRP STxMP MAC CE based on a determination that a single entry PHR is used.

In some embodiments, generating comprises generating the enhanced multiple entry PHR for multiple TRP STxMP MAC CE based on a determination that multiple PHRs are configured.

In some embodiments, the enhanced single entry PHR for multiple TRP STxMP MAC CE includes two sets of fields, each set including a power headroom (PH) field and a configured transmitted power field. The PH field indicates a type-1 power headroom level, and the configured transmitted power field indicates a configured maximum output power that is used for calculation of a preceding PH field. A first PH field in a first set of fields is associated with a first transmission configuration indicator (TCI) state for a first physical uplink shared channel (PUSCH) transmission, and a second PH field in a second set of fields is associated with a second TCI state for a second PUSCH transmission.

In some embodiments, each set further includes a field indicating whether a corresponding PH field is associated with a real PUSCH transmission or a reference PUSCH transmission.

In some embodiments, the enhanced multiple entry PHR for multiple TRP STxMP MAC CE includes two sets of fields for each reported serving cell that is configured with the multi-panel scheme, each set including a PH field and a configured transmitted power field. The PH field indicates a type-1 power headroom level and the configured transmitted power field indicates a configured maximum output power that is used for calculation of a preceding PH field. A first PH field in a first set of fields is associated with a first TCI state for a first PUSCH transmission, and a second PH field in a second set of fields is associated with a second TCI state for a second PUSCH transmission.

In some embodiments, each set further includes a field indicating whether a corresponding PH field is associated with a real PUSCH transmission or a reference PUSCH transmission.

In some embodiments, the each set further includes a maximum permissible exposure (MPE) information associated with a corresponding configured transmitted power field for the serving cell operating on frequency range 2 (FR 2).

In some embodiments, the method further comprises, for the enhanced multiple entry PHR for multiple TRP STxMP MAC CE, obtaining two type-1 PH values for a corresponding uplink carrier for the serving cell. Each type-1 PH value indicates a difference between a nominal UE maximum transmit power and an estimated power for an uplink shared channel (UL-SCH) transmission.

In some embodiments, the method further comprises, for the enhanced single entry PHR for multiple TRP STxMP MAC CE, obtaining two type-1 PH values and two configured transmitted power values for a corresponding uplink carrier for a primary cell Each type-1 PH value indicates a difference between a nominal UE maximum transmit power and an estimated power for a UL-SCH transmission.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows an example process at UE for a power headroom reporting for multi-TRP STxMP operation in accordance with an embodiment.

FIG. 5 shows an example process at BS for a power headroom reporting for multi-TRP STxMP operation in accordance with an embodiment.

FIG. 6 shows an example Enhanced Multiple Entry PHR for multiple TRP STxMP MAC CE in accordance with an embodiment.

FIG. 7 shows an example of Enhanced Multiple Entry PHR for multiple TRP STxMP MAC CE in accordance with an embodiment.

FIG. 8 shows an example of reporting two serving cells in Enhanced Multiple Entry PHR for multiple TRP STxMP MAC CE in accordance with an embodiment.

FIG. 9 shows an example Enhanced Single Entry PHR for multiple TRP STxMP MAC CE in accordance with an embodiment.

FIG. 10 shows an example Enhanced Single Entry PHR for multiple TRP STxMP MAC CE in accordance with an embodiment.

FIG. 11 shows an example Enhanced Multiple Entry PHR for multiple TRP STxMP MAC CE with the highest ServCellIndex of Serving Cell with configured uplink is less than 8 in accordance with an embodiment.

FIG. 12 shows an example Enhanced Multiple Entry PHR for multiple TRP STxMP MAC CE with the highest ServCellIndex of Serving Cell with configured uplink is equal to or higher than 8 in accordance with an embodiment.

FIG. 13 shows an example Enhanced Multiple Entry PHR for multiple TRP STxMP MAC CE with the highest ServCellIndex of Serving Cell with configured uplink is less than 8 in accordance with an embodiment.

FIG. 14 shows an example Enhanced Multiple Entry PHR for multiple TRP STxMP MAC CE with the highest ServCellIndex of Serving Cell with configured uplink is equal to or higher than 8 in accordance with an embodiment.

FIG. 15 shows an Enhanced Multiple Entry PHR for multiple TRP STx2P MAC CE with the highest ServCellIndex of Serving Cell with configured uplink is less than 8.

FIG. 16 shows an Enhanced Multiple Entry PHR for multiple TRP STx2P MAC CE with the highest ServCellIndex of Serving Cell with configured uplink is less than 8.

FIG. 17 shows an Enhanced Multiple Entry PHR for multiple TRP STx2P MAC CE with the highest ServCellIndex of Serving Cell with configured uplink is equal to or higher than 8.

FIG. 18 shows an Enhanced Multiple Entry PHR for multiple TRP STx2P MAC CE with the highest ServCellIndex of Serving Cell with configured uplink is equal to or higher than 8.

FIG. 19 shows an example per BWP configuration in accordance with an embodiment.

FIG. 20 shows an example Enhanced Multiple Entry PHR for multiple TRP STx2P MAC CE with the highest ServCellIndex of Serving Cell with configured uplink is less than 8 in accordance with an embodiment.

FIG. 21 shows an example Enhanced Multiple Entry PHR for multiple TRP STx2P MAC CE with the highest ServCellIndex of Serving Cell with configured uplink is equal to or higher than 8 in accordance with an embodiment.

FIG. 22 shows an example Enhanced Multiple Entry PHR for multiple TRP STx2P MAC CE with BWP ID and the highest ServCellIndex of Serving Cell with configured uplink is less than 8 in accordance with an embodiment.

FIG. 23 shows an example Enhanced Multiple Entry PHR for multiple TRP STx2P MAC CE with BWP ID and the highest ServCellIndex of Serving Cell with configured uplink is equal to or higher than 8 in accordance with an embodiment.

FIG. 24 shows an example Enhanced Multiple Entry PHR for multiple TRP STx2P MAC CE with fields bitmap and the highest ServCellIndex of Serving Cell with configured uplink is less than 8 in accordance with an embodiment.

FIG. 25 shows an example Enhanced Multiple Entry PHR for multiple TRP STx2P MAC CE with fields bitmap and the highest ServCellIndex of Serving Cell with configured uplink is equal to or higher than 8 in accordance with an embodiment.

FIG. 26 shows an example process at UE for a power headroom reporting for multi-TRP STxMP operation in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic having dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHz, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

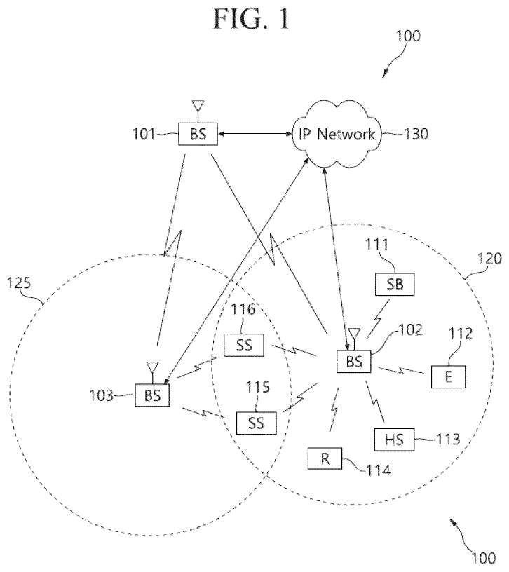

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (TP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with APs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or 103 can communicate directly with IP network 130 and provide UEs with direct wireless broadband access to the network 130. Further, gNB 101, 102, and/or 103 can provide access to other or additional external networks, such as external telephone networks or other types of data networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101 (FIG. 1). For example, the controller/processor may control the reception of uplink signals and the transmission of downlink signals by the UEs, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

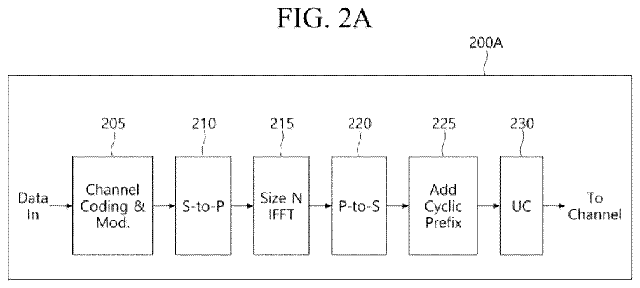

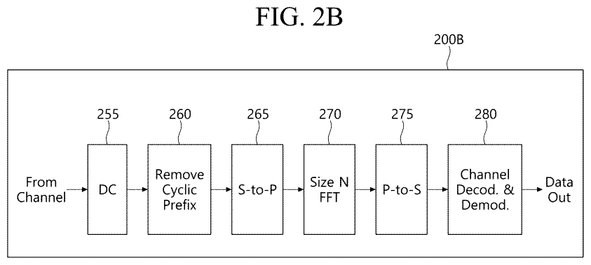

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1). The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory(ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

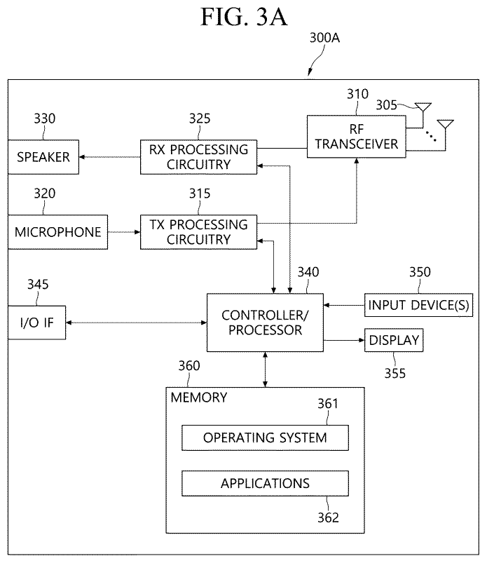

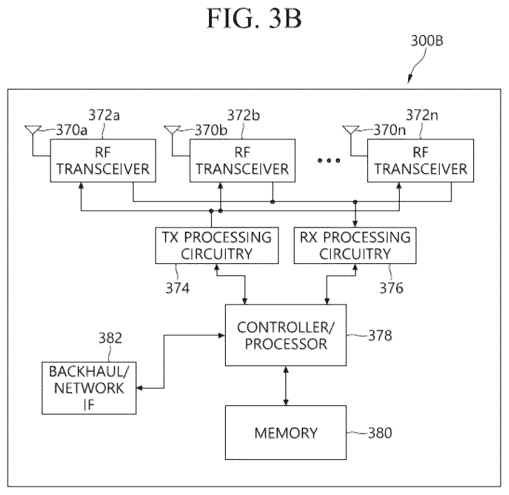

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 coupled to the processor 340, directly or through intervening elements. The main processor 340 is also capable of executing other processes and programs resident in the memory 360, such as CLTM in wireless communication systems as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. The main processor 340 is also coupled to the I/O interface 345, which provides the UE 300A with the ability to connect to other devices such as laptop computers and handheld computers. The I/O interface 345 is the communication path between these accessories and the main controller 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting CLTM in wireless communication systems as described in embodiments of the present disclosure. In some embodiments, the controller/processor 378 supports communications between entities, such as web RTC. The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning an uplink of transceiver to a certain frequency and establishing the downlink using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one transmission or receive per RF transceiver).

As an example, Release13 of the LTE standard supports up to 16 CSI-RS [channel status information—reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel.14 LTE. For next generation cellular systems such as 5G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power) and reports the results to the BS.

The BS 300B of FIG. 3B may also include additional or different types of memory 380, including dynamic random-access memory (DRAM), non-volatile flash memory, static RAM (SRAM), different levels of cache memory. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms (e.g., CLTM) may be formulated by the inventors and designed to assist in providing an efficient description of the unique features within the disclosure. A list of both common and unique acronyms follows.

### Abbreviations

L1 Layer 1
L2 Layer 2
L3 Layer 3
UE User Equipment
gNB Base Station
NW Network
NR New Radio
3GPP 3rd Generation Partnership Project
HO Handover
CHO Conditional Handover
CE Control Element
FR Frequency Range
MAC Medium Access Control
MCG Master Cell Group
SCG Secondary Cell Group
AS Access Stratum
MPE Maximum Permissible Exposure
NAS Non-access Stratum
RRC Radio Resource Control
DCI Downlink Control Information
DU Distributed Unit
CU Central Unit
UL-SCH Uplink Shared Channel
DL-SCH Downlink Shared Channel
DL Downlink
UL Uplink
PUSCH Physical Uplink Shared Channel
PUCCH Physical Uplink Control Channel
SpCell Special Cell
SCell Secondary Cell
PCell Primary Cell
PSCell Primary Secondary Cell
TCI Transmission Configuration Indicator
TRP Transmit-Receive Point
SRS Sounding Reference Signal

The following documents are hereby incorporated by reference in their entirety into the present disclosure as if fully set forth herein: i) 3GPP TS 38.300 v17.6.0; ii) 3GPP TS 38.331 v17.6.0; and iii) 3GPP TS 38.321 v17.6.0.

3GPP (Third-Generation Partnership Project) has developed technical specifications and standards to define the new 5G radio-access technology, known as 5G NR. Multiple-Input Multiple-Output (MIMO) is a critical aspect in any mobile communication system, including 5G system, and has demonstrated its success in commercial deployment. In multi-TRP operations, a serving cell can schedule a UE from two TRPs to provide better coverage, reliability, and data rates for both downlink and uplink transmissions. Two operation modes are supported for scheduling multi-TRP transmissions: i) single-DCI, in which the UE is scheduled by the same DCI for both TRPs, and ii) multi-DCI, in which the UE is scheduled by independent DCIs from each TRP.

For single-DCI multi-TRP Simultaneous Transmission with Multi-Panel (STxMP) Spatial Domain Multiplexing (SDM) PUSCH transmission, different layers of one PUSCH are separately transmitted towards two TRPs. For single-DCI multi-TRP STxMP Single Frequency Network (SFN) PUSCH transmission, same layers of one PUSCH are transmitted towards two TRPs. For multi-DCI multi-TRP STxMP PUSCH+PUSCH transmission, two PUSCHs are transmitted towards two TRPs. For single-DCI multi-TRP STxMP SFN PUCCH transmission, one PUCCH is transmitted towards two TRPs.

For single-DCI multi-TRP STxMP transmission, the network configures the maximum transmission powers per panel which can, for example, be indicated by TCI state signaling. Additionally, a power headroom reporting (PHR) per panel is needed for UL power control. PH and configured maximum transmission power for multiple number of serving cells are reported by an MAC CE.

The present disclosure presents various embodiments of how UE performs PHR for single-DCI multi-TRP STxMP transmission. Additionally, the present disclosure provides various embodiments of how to design MAC CEs for reporting PH and the configured maximum transmission power for multiple serving cells.

In some embodiments, UE first receives a STxMP configuration or/and a PHR configuration from the BS. The STxMP configuration may be included in UE-specific PUSCH configuration for a bandwidth part (BWP) for a serving cell in an RRC message, such as an RRCReconfiguration message. The STxMP configuration may include parameters to set up the STxMP operation, including multi-panel scheme with SDM or SFN, which is indicated by the field multipanelScheme in the STxMP configuration. The PHR configuration may be included in a MAC entity configuration in an RRC message, such as the RRCReconfiguration message. The PHR configuration may include an indication of enabling two-PHR mode. In an embodiment, the network configures an RRC parameter, twoPHRmode, which indicates whether the power headroom reported with two PHRs for a cell group (e.g., a MAC entity) (each PHR associated with an SRS resource set) is enabled or not. In another embodiment, the network configures an RRC parameter, twoPHRmodeSTxMP, which indicates whether the power headroom reported with two PHRs specifically for multi-TRP STxMP operation (each PHR associated with an SRS resource set) is enabled or not. In this disclosure, twoPHRmode, twoPHRmodeSTxMP, and two-PHR mode are used interchangeably to denote an RRC parameter configuring two PHR modes for a MAC entity.

In some embodiments, when a multi-panel scheme is configured for at least a serving cell belonging to a cell group (i.e., an MAC entity), the network configures two-PHR mode for this cell group (i.e., MAC entity).

Based on the configurations, UE performs the STxMP operation and the PHR procedure. When the MAC entity of UE is configured with twoPHRmode and multipanelScheme is configured for at least a serving cell to which the MAC entity belongs, and the PHR is triggered for the serving cell, UE sends an enhanced single-entry PHR for Multi-TRP STxMP MAC CE and/or an Enhanced multi-entry PHR for Multi-TRP STxMP MAC CE to the base station (BS).

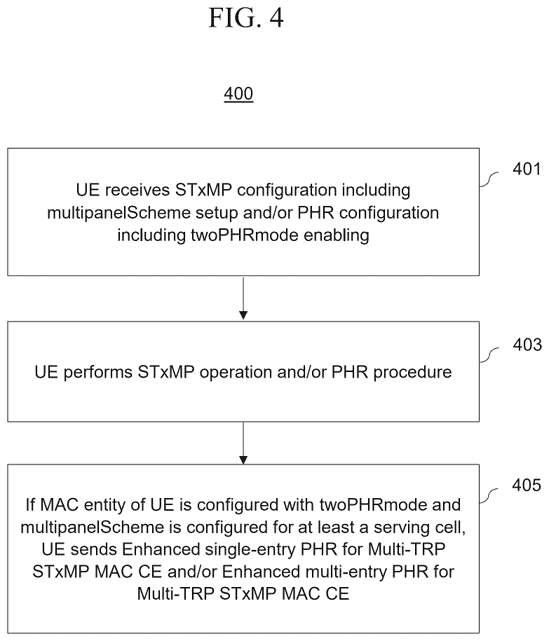

FIG. 4 shows an example process 400 at UE for a power headroom reporting for multi-TRP STxMP operation in accordance with an embodiment. For explanatory and illustration purposes, the example process 400 may be performed by a UE. Although one or more operations are described or shown in particular sequential order, in other embodiments the operations may be rearranged in a different order, which may include performance of multiple operations in at least partially overlapping time periods.

Referring to FIG. 4, the process 400 may begin in operation 401. In operation 401, UE receives an STxMP configuration and/or a PHR configuration. The STxMP configuration may include multipanelScheme setup information. The PHR configuration may include twoPHRmode enabling information. Then, the process 400 proceeds to operation 403.

In operation 403, UE performs STxMP operation and/or PHR procedure based on the STxMP configuration and the PHR configuration, respectively. Then, the process 400 proceeds to operation 405.

In operation 405, if the MAC entity of UE is configured with twoPHRmode and multipanelScheme is configured for at least a serving cell to which the MAC entity belongs, UE sends an enhanced single-entry PHR for Multi-TRP STxMP MAC CE and/or an enhanced multi-entry PHR for Multi-TRP STxMP MAC CE.

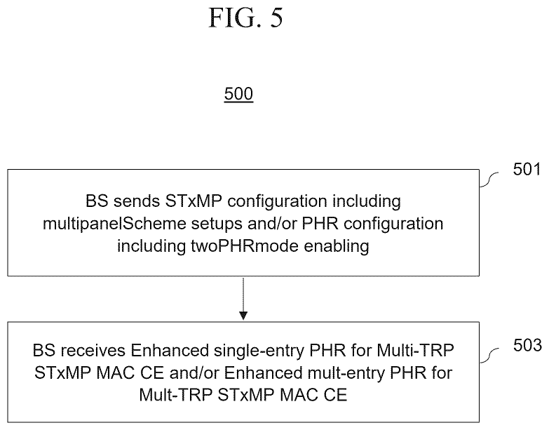

FIG. 5 shows an example process 500 at BS for a power headroom reporting for multi-TRP STxMP operation in accordance with an embodiment. For explanatory and illustration purposes, the example process 500 may be performed by a UE. Although one or more operations are described or shown in particular sequential order, in other embodiments the operations may be rearranged in a different order, which may include performance of multiple operations in at least partially overlapping time periods.

Referring to FIG. 5, the process 500 may begin in operation 501. In operation 501, BS transmits, to UE, an STxMP configuration and/or a PHR configuration. The STxMP configuration may include multipanelScheme setup information. The PHR configuration may include twoPHRmode enabling information. Then, the process 500 proceeds to operation 503.

In operation 503, BS receives, from UE, an enhanced single-entry PHR for Multi-TRP STxMP MAC CE and an enhanced multi-entry PHR for Multi-TRP STxMP MAC CE.

In some embodiments, UE performs PHR procedure for single-DCI based multi-TRP STxMP, as follows:
1> if the Power Headroom reporting procedure determines that at least one PHR has been triggered and not cancelled; and
1> if the allocated UL resources can accommodate the MAC CE for PHR which the MAC entity is configured to transmit, plus its subheader:
   2> if multiplePHR with value true is configured:
      3> for each activated Serving Cell with configured uplink associated with any MAC entity of which the active DL BWP is not dormant BWP; and
      3> for each activated Serving Cell with configured uplink associated with E-UTRA MAC entity:
         4> if this MAC entity is configured with twoPHRMode:
         5> if this Serving Cell is configured with multiple TRP PUSCH repetition and the MAC entity this Serving Cell belongs to is configured with twoPHRMode: or
         5> if this Serving Cell is configured with multipanelScheme and the MAC entity this Serving Cell belongs to is configured with twoPHRMode:
         6> obtain two values of the Type 1 or the value of Type 3 power headroom for the corresponding uplink carrier for NR Serving Cell.
         5> else if this Serving Cell is configured with multipanelScheme (i.e., single-DCI based multi-TRP STxMP operation) and the MAC entity this Serving Cell belongs to is configured with twoPHRMode, or
         5> if this Serving Cell is configured with sTx-2Panel (i.e., multi-DCI based multi-TRP STxMP operation) and the MAC entity this Serving Cell belongs to is not configured with twoPHRMode:
         6> obtain two values of the Type 1 power headroom for the corresponding uplink carrier for NR Serving Cell.
         5> else:
         6> obtain the value of the Type 1 or Type 3 power headroom for the corresponding uplink carrier for NR Serving Cell and for E-UTRA Serving Cell.
         4> else (i.e. this MAC entity is not configured with twoPHRMode):
         5> if this Serving Cell is configured with multipanelSchemeSDM or multipanelSchemeSFN and if the MAC entity this Serving Cell belongs to is configured with twoPHRMode:
         6> obtain two values of the Type 1 power headroom for the corresponding uplink carrier for NR Serving Cell.
         5> if this Serving Cell is configured with multiple TRP PUSCH repetition and the MAC entity this Serving Cell belongs to is configured with twoPHRMode:
         6> if there is at least one real PUSCH transmission at the slot where the PHR MAC CE is transmitted:
         7> obtain the value of the Type 1 power headroom of the first real transmission of the corresponding uplink carrier for NR Serving Cell.
         6> else if there is no real PUSCH transmission at the slot where the PHR MAC CE is transmitted:
         7> obtain the value of the type 1 power headroom of the reference PUSCH transmission associated with the SRS-ResourceSet with a lower SRS-resourceSetID or the value of the type 3 power headroom for the corresponding uplink carrier for NR Serving Cell.
      5> else:
         6> obtain the value of the Type 1 or Type 3 power headroom for the corresponding uplink carrier for NR Serving Cell and for E-UTRA Serving Cell.
   3> instruct the Multiplexing and Assembly procedure to generate and transmit the Enhanced Multiple Entry PHR for multiple TRP STxMP MAC CE if this MAC entity is configured with twoPHRMode and at least a serving cell belonging to this MAC entity to be reported is configured with multipanelScheme (i.e., single-DCI based multi-TRP STxMP operation) or sTx-2Panel (i.e., multi-DCI based multi-TRP STxMP operation) based on the values reported by the physical layer.
2> else (i.e. Single Entry PHR format is used):
   3> if this MAC entity is configured with twoPHRMode:
      4> obtain two values of the Type 1 power headroom from the physical layer for the corresponding uplink carrier of the PCell.
   3> else:
      4> obtain the value of the Type 1 power headroom from the physical layer for the corresponding uplink carrier of the PCell.
   3> if multipanelScheme is configured for the PCell, or,
   3> if sTx-2Panel (i.e., multi-DCI based multi-TRP STxMP operation) is configured for the PCell
      4> obtain two values for the corresponding P_{CMAX,f,c} fields from the physical layer;
   3> else:
      4> obtain the value for the corresponding P_{CMAX,f,c} field from the physical layer;
   3> instruct the Multiplexing and Assembly procedure to generate and transmit the Enhanced Single Entry PHR for multiple TRP STxMP MAC CE if this MAC entity is configured with twoPHRMode and at least one serving cell belonging to the MAC entity to be reported is configured with multipanelScheme (i.e., single-DCI based multi-TRP STxMP operation) or sTx-2Panel (i.e., multi-DCI based multi-TRP STxMP operation) based on the values reported by the physical layer.
2> if this PHR report is an MPE P-MPR report:
   3> start or restart the mpe-ProhibitTimer;
   3> cancel triggered MPE P-MPR reporting for Serving Cells included in the PHR MAC CE.
2> start or restart phr-Periodic Timer;
2> start or restart phr-ProhibitTimer;
2> cancel all triggered PHR(s).

In some embodiments, the PHR procedure is used to provide the serving gNB with the following information:
Type 1 power headroom: the difference between the nominal UE maximum transmit power and the estimated power for UL-SCH transmission per activated Serving Cell;
Type 2 power headroom: the difference between the nominal UE maximum transmit power and the estimated power for UL-SCH and PUCCH transmission on SpCell of the other MAC entity;
Type 3 power headroom: the difference between the nominal UE maximum transmit power and the estimated power for SRS transmission per activated Serving Cell;
MPE P-MPR: the power backoff to meet the MPE FR2 requirements for a Serving Cell operating on FR2;
DPC: the adjustment to maximum output power for a given power class for a Serving Cell operating on FR1;
DPC_{BC}: the adjustment to maximum output power for a given power class for a Band Combination operating on FR1.

Table 1 shows values of one-octet eLCID (extended logical channel identifier) for UL-SCH. Referring to Table 1, the Enhanced Multiple Entry PHR for multiple TRP STxMP MAC CE (four octets Cᵢ), Enhanced Multiple Entry PHR for multiple TRP STxMP (one octets Cᵢ), and Enhanced Single Entry PHR for multiple TRP STxMP may be identified by a MAC subheader with eLCID. In an embodiment, X1, X2, and X3 can be 220, 221, and 222, respectively, while Y1, Y2, and Y3 can be 284, 285, and 286, respectively.

TABLE 1

| Codepoint | Index | LCID values |
|---|---|---|
| X1 | Y1 | Enhanced Multiple Entry PHR for multiple TRP |
| | | STxMP (four octets Cᵢ) |
| X2 | Y2 | Enhanced Multiple Entry PHR for multiple TRP |
| | | STxMP (one octets Cᵢ) |
| X3 | Y3 | Enhanced Single Entry PHR for multiple TRP |
| | | STxMP |

The MAC CEs has a variable size, and includes the bitmaps, Type 2 PH field(s) and octet(s) containing the associated P_{CMAX,f,c} field(s) (if reported) for SpCell of the other MAC entity, Type 1 PH field(s) and octet(s) containing the associated P_{CMAX,f,c} field(s) (if reported) for the PCell. It further includes, in ascending order based on the ServCellIndex, one or multiple of Type X PH fields and octets containing the associated P_{CMAX,f,c} fields (if reported) for Serving Cells other than PCell indicated in the bitmap for indicating the presence of PH(s). X is either 1 or 3. The presence of Type 2 PH field for SpCell of the other MAC entity is configured by phr-Type2OtherCell with value true.

A single octet bitmap is used for indicating the presence of PH(s) per Serving Cell when the highest ServCellIndex of Serving Cell with configured uplink is less than 8, otherwise four octets are used. If the MAC entity is configured with two PHR Mode and at least one serving cell configured multipanelScheme is present, the MAC CE is applied.

The MAC entity determines whether PH value for an activated Serving Cell is based on real transmission or a reference format by considering the configured grant(s) and downlink control information which has been received until and including the PDCCH occasion in which the first UL grant for a new transmission that can accommodate the MAC CE for PHR as a result of logical channel prioritization (LCP) is received since a PHR has been triggered if the PHR MAC CE is reported on an uplink grant received on the PDCCH or until the first uplink symbol of PUSCH transmission minus PUSCH preparation time if the PHR MAC CE is reported on a configured grant.

For a band combination in which the UE does not support dynamic power sharing, the UE may omit the octets containing Power Headroom field and P_{CMAX,f,c} field for Serving Cells in the other MAC entity except for the PCell in the other MAC entity and the reported values of Power Headroom and P_{CMAX,f,c} for the PCell are up to UE implementation. P_{CMAX,f,c} may be the UE configured maximum output power for carrier f of serving cell c in PUSCH transmission occasion.

The Enhanced Multiple Entry PHR for multiple TRP MAC CEs may include the following fields:
Cᵢ: This field indicates the presence of PH field(s) for the Serving Cell with ServCellIndex
i. The Cᵢ field set to 1 indicates that PH field(s) for the Serving Cell with ServCellIndex i is reported. The Cᵢ field set to 0 indicates that a PH field for the Serving Cell with ServCellIndex i is not reported;
If serving cell is configured with two PHR Mode and multipanelScheme in RRCReconfiguration received from gNB:
   Include two PH fields and two P_{CMAX,f,c} fields in the MAC CE for this Serving Cell
If serving cell is configured with two PHR Mode and not configured with multipanelScheme in RRCReconfiguration received from gNB:
   include two PH fields and one P_{CMAX,f,c} field in the MAC CE for this Serving Cell
If serving cell is not configured with two PHR Mode and not configured with multipanelScheme in RRCReconfiguration received from gNB:
   include one PH field and one P_{CMAX,f,c} field in the MAC CE for this Serving Cell
R: Reserved bit, set to 0;
V: This field indicates if the PH value is based on a real transmission or a reference format. For Type 1 PH, the V field set to 0 indicates real transmission on PUSCH and the V field set to 1 indicates that a PUSCH reference format is used. For Type 2 PH, the V field set to 0 indicates real transmission on PUCCH and the V field set to 1 indicates that a PUCCH reference format is used. For Type 3 PH, the V field set to 0 indicates real transmission on SRS and the V field set to 1 indicates that an SRS reference format is used. Furthermore, for Type 1, Type 2, and Type 3 PH, the V field set to 0 indicates the presence of the octet containing the associated P_{CMAX,f,c} field and the MPE field, and all of the V field(s) for the Serving Cell set to 1 indicates that the octet containing the associated P_{CMAX,f,c} field and the MPE field is omitted;
Power Headroom i (PH i): This field indicates the power headroom level, where PH 1 is associated with the SRS-ResourceSet with a lower srs-ResourceSetId and PH 2 is associated with the SRS-ResourceSet with a higher srs-ResourceSetld. PH fields for a Serving Cell are included in ascending order based on i, where i=1,2. The length of the field is 6 bits.;
P: If mpe-Reporting-FR2 is configured and the Serving Cell operates on FR2, the MAC entity may set this field to 0 if the applied P-MPR value, to meet MPE requirements is less than P-MPR_00 and to 1 otherwise. If mpe-Reporting-FR2 is not configured or the Serving Cell operates on FR1, this field indicates whether power backoff is applied due to power management. The MAC entity may set the P field to 1 if the corresponding P_{CMAX,f,c} field would have had a different value if no power backoff due to power management had been applied;
P_{CMAX,f,c,i}: If present, this field indicates the P_{CMAX,f,c,i} for the NR Serving Cell and the P_{CMAX,c} or \tilde{P}_{CMAX,c} for the E-UTRA Serving Cell used for calculation of the preceding PH i field, where i=1, 2. The reported P_{CMAX,f,c,i} and the corresponding nominal UE transmit power levels, the corresponding measured values in dBm for the NR Serving Cell, and the corresponding measured values in dBm for the E-UTRA Serving Cell are specified according to various embodiments;
MPE: If mpe-Reporting-FR2 is configured, and the Serving Cell operates on FR2, and if the P field is set to 1, this field indicates the applied power backoff to meet MPE requirements. The length of the field is 2 bits. If mpe-Reporting-FR2 is not configured, or if the Serving Cell operates on FR1, or if the P field is set to 0, R bits are present instead.

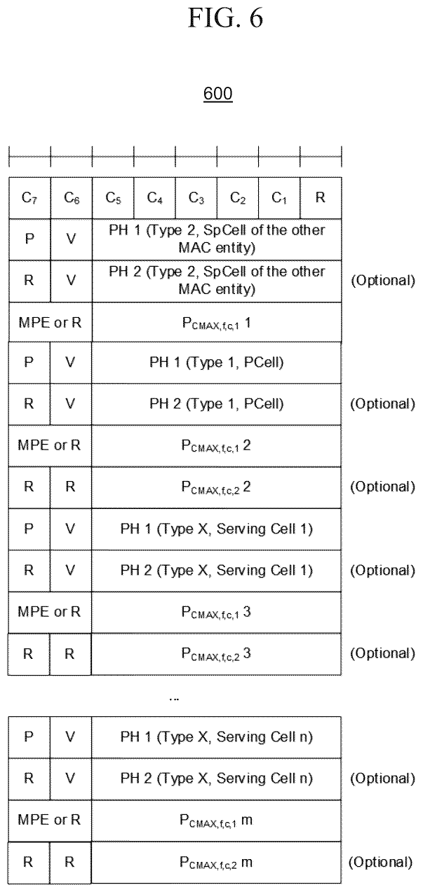

FIG. 6 shows an example Enhanced Multiple Entry PHR for multiple TRP STxMP MAC CE 600 in accordance with an embodiment. In this example, the highest ServCellIndex of Serving Cell with configured uplink is less than 8.

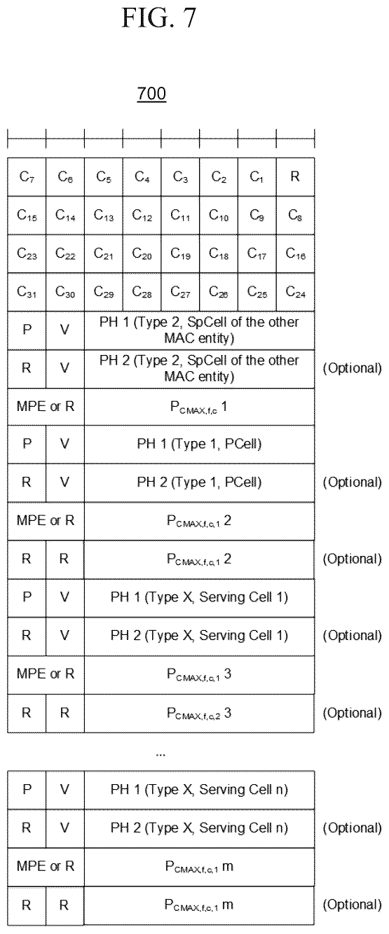

FIG. 7 shows an example of Enhanced Multiple Entry PHR for multiple TRP STxMP MAC CE 700 in accordance with an embodiment. In this example, the highest ServCelllndex of Serving Cell with configured uplink is equal to or higher than 8.

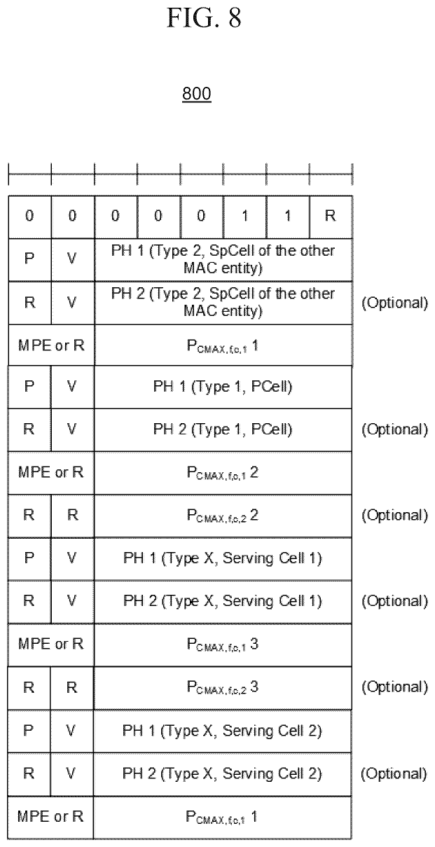

FIG. 8 shows an example of reporting two serving cells in Enhanced Multiple Entry PHR for multiple TRP STxMP MAC CE 800 in accordance with an embodiment. In this example, the highest ServCelllndex of Serving Cell with configured uplink is less than 8.

The example shown in FIG. 8 is for the case serving cells with ServCellIndex 1 and 2 are reported in the PHR MAC CE. The serving cell with ServCellIndex 1 is configured with two PHR Mode and multipanelScheme, two PH fields and two P_{CMAX,f,c,i} fields are included in the MAC CE for this Serving Cell. The serving cell with ServCellIndex 2 is configured with two PHR Mode and not configured with multipanelScheme, include two PH fields and one P_{CMAX,f,c,i} field in the MAC CE for this Serving Cell.

In some embodiments, the Enhanced Single Entry PHR for multiple TRP STxMP MAC CE may be identified by a MAC subheader with eLCID as shown in Table 1. The MAC CE may be applied for the serving cell if the MAC entity is configured with twoPHRMode and the serving cell is configured with multipanelScheme.

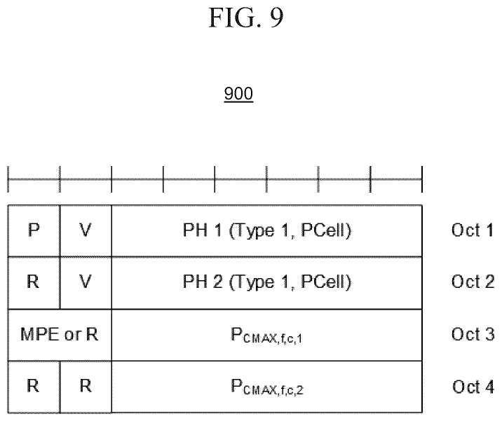

FIG. 9 shows an example Enhanced Single Entry PHR for multiple TRP STxMP MAC CE 900 in accordance with an embodiment.

Referring to FIG. 9, the MAC CE 900 has a fixed size and includes three octets. The MAC CE 900 includes the following fields:
R: Reserved bit, set to 0;
Power Headroom i (PH i): This field indicates the power headroom level, where PH 1 is associated with the SRS-ResourceSet with a lower srs-ResourceSetId and PH 2 is associated with the SRS-ResourceSet with a higher srs-ResourceSetld. PH fields for a Serving Cell are included in ascending order based on i. The length of the field is 6 bits;
P: If mpe-Reporting-FR2 is configured and the Serving Cell operates on FR2, the MAC entity may set this field to 0 if the applied P-MPR value, to meet MPE requirements is less than P-MPR_00 and to 1 otherwise. If mpe-Reporting-FR2 is not configured or the Serving Cell operates on FR1, this field indicates whether power backoff is applied due to power management. The MAC entity may set the P field to 1 if the corresponding P_{CMAX,f,c} field would have had a different value if no power backoff due to power management had been applied;
V: This field indicates if the PH value for the corresponding TRP is based on a real transmission or a reference format. For Type 1 PH, the V field set to 0 indicates real transmission on PUSCH and the V field set to 1 indicates that a PUSCH reference format is used;
P_{CMAX,f,c,i}: This field indicates the P_{CMAX,f,c,i} used for calculation of the preceding PH i field, where i=1,2;
MPE: If mpe-Reporting-FR2 is configured, and the Serving Cell operates on FR2, and if the P field is set to 1, this field indicates the applied power backoff to meet MPE requirements. This field indicates an index and the corresponding measured values of P-MPR levels in dB. The length of the field is 2 bits. If mpe-Reporting-FR2 is not configured, or if the Serving Cell operates on FR1, or if the P field is set to 0, R bits are present instead.

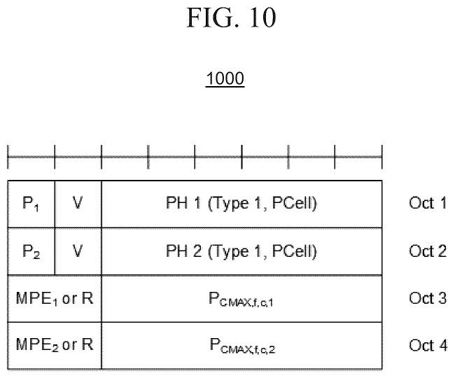

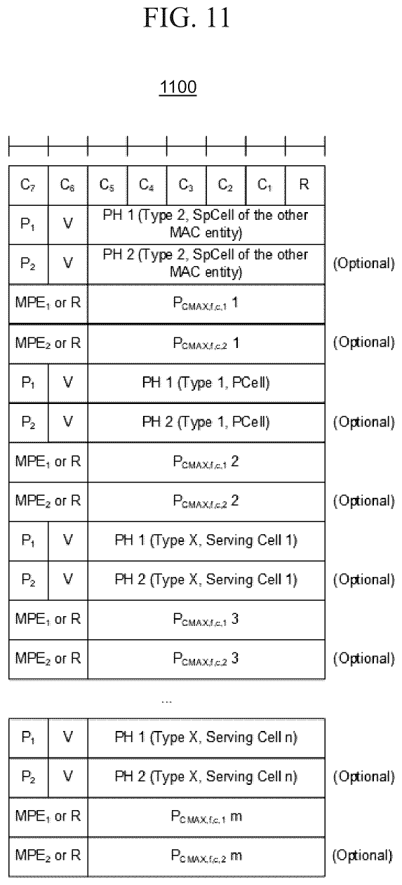

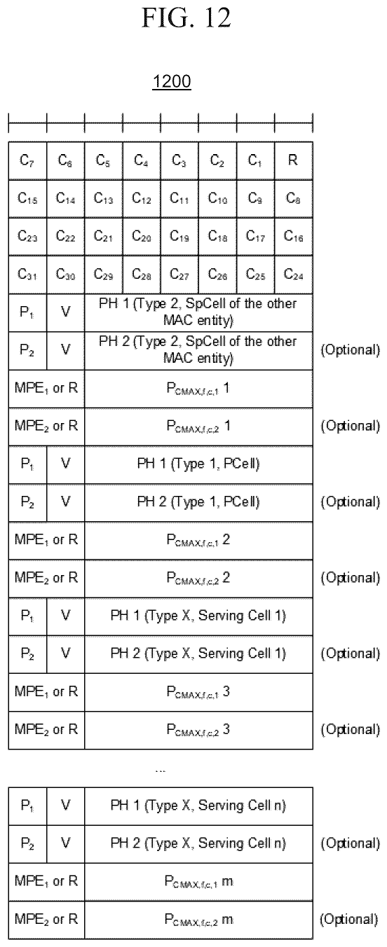

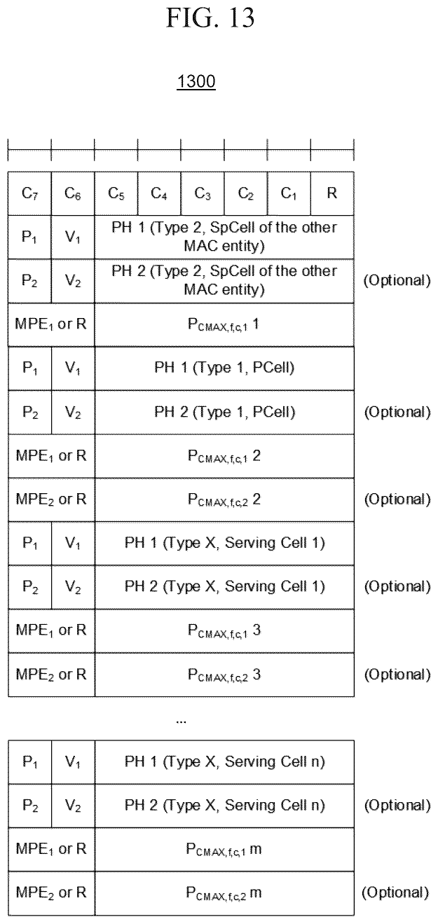

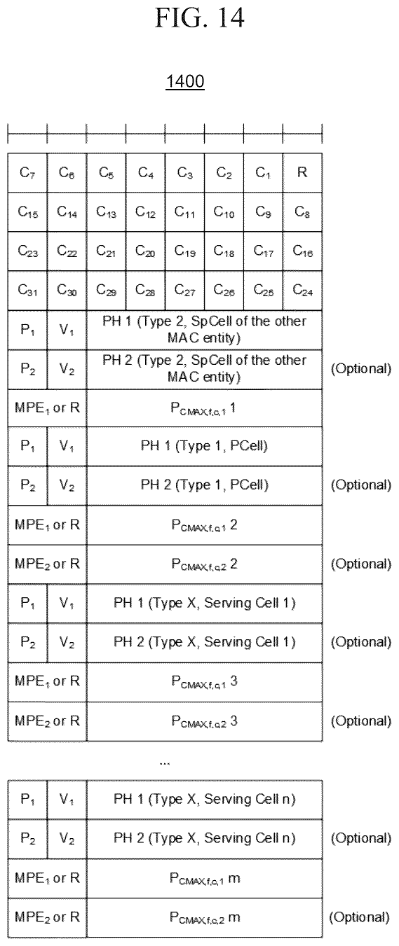

In some embodiments, two PH values, two P_{CMAX,f,c} values, two P values, two V values, and two MPE values are reported. FIG. 10 shows an example single-entry PHR MAC CE, and FIGS. 11 and 12 show examples of multi-entry PHR MAC CEs. Additional examples are shown in FIGS. 13 and 14.

For single-enty PHR MAC CE, the MAC CE is applied for the Serving Cell if the MAC entity is configured with twoPHRMode and the serving cell is configured with multipanelScheme.

For multi-enty PHR MAC CE, if the serving cell indicated by Cᵢ field is present and configured with two PHR Mode and multipanelScheme in RRCReconfiguration received from gNB, the MAC CEs include two PH fields, two P_{CMAX,f,c fields, two P fields and two MPE fields, in the MAC CE for this Serving Cell.}

FIG. 10 shows an example Enhanced Single Entry PHR for multiple TRP STxMP MAC CE 1000 in accordance with an embodiment.

FIG. 11 shows an example Enhanced Multiple Entry PHR for multiple TRP STxMP MAC CE 1100 with the highest ServCellIndex of Serving Cell with configured uplink is less than 8 in accordance with an embodiment.

FIG. 12 shows an example Enhanced Multiple Entry PHR for multiple TRP STxMP MAC CE 1200 with the highest ServCellIndex of Serving Cell with configured uplink is equal to or higher than 8 in accordance with an embodiment.

FIG. 13 shows an example Enhanced Multiple Entry PHR for multiple TRP STxMP MAC CE 1300 with the highest ServCellIndex of Serving Cell with configured uplink is less than 8 in accordance with an embodiment.

FIG. 14 shows an example Enhanced Multiple Entry PHR for multiple TRP STxMP MAC CE 1400 with the highest ServCellIndex of Serving Cell with configured uplink is equal to or higher than 8 in accordance with an embodiment.

Followings are detailed description of fields included in the MAC CE shown in FIGS. 10-14.

Power Headroom k (PH k): This field indicates the power headroom level. For PHR with twoPHRmode, if the Serving cell is configured with multipanelSchemeSFN or multipanelSchemeSDM, PH 1 is associated with the first TCI-State or TCI-UL-State for a real or reference PUSCH transmission and PH 2 is associated with the second TCI-State or TCI-UL-State for a real or reference PUSCH transmission. Otherwise (if the serving cell is configured with multi-TRP PUSCH repetition), PH 1 is associated with the SRS-ResourceSet with a lower srs-ResourceSetId and PH 2 is associated with the SRS-ResourceSet with a higher srs-ResourceSetld. PH fields for a Serving Cell are included in ascending order based on k. The length of the field is 6 bits. The reported PH and the corresponding power headroom levels and the corresponding measured values in dB for the NR Serving Cell may be predetermined;
Pᵢ: If mpe-Reporting-FR2 is configured and the Serving Cell operates on FR2, the MAC entity may set this field to 0 if the applied P-MPR value associated with the i-th TRP or the i-th indicated TCI state or PH i in the same octect or the next/subsequent/following P_{CMAX,f,c,i} (i=1,2) to meet MPE requirements is less than P-MPR_00 (predetermined). Otherwise it may be set to 1. If mpe-Reporting-FR2 is not configured or the Serving Cell operates on FR1, this field indicates whether power backoff is applied due to power management for the i-th TRP or the i-th indicated TCI state or PH i or \tilde{P}_{CMAX,f,c,i} (i=1,2). The MAC entity may set the Pᵢ field to 1 if the corresponding P_{CMAX,f,c,i} field would have had a different value if no power backoff due to power management had been applied;
MPEᵢ: If mpe-Reporting-FR2 is configured, and the Serving Cell operates on FR2, and if the preceding Pᵢ field is set to 1, this field indicates the applied power backoff to meet MPE requirements. The length of the field is 2 bits. If mpe-Reporting-FR2 is not configured, or if the Serving Cell operates on FR1, or if the Pᵢ field is set to 0, R bits are present instead.
Vᵢ: This field indicates if the PH i value in the same octect is based on a real transmission or a reference format. For Type 1 PH, the Vᵢ field set to 0 indicates real transmission on PUSCH and the Vᵢ field set to 1 indicates that a PUSCH reference format is used. For Type 2 PH, the Vᵢ field set to 0 indicates real transmission on PUCCH and the Vᵢ field set to 1 indicates that a PUCCH reference format is used. For Type 3 PH, the Vₖ field set to 0 indicates real transmission on SRS and the Vₖ field set to 1 indicates that an SRS reference format is used. In addition, for Type 2 PH and Type 3 PH, the Vₖ field set to 0 indicates the presence of the octet containing the associated P_{CMAX,f,c,k} field and the MPEₖ field.

In some embodiments, P value and MPE value are not reported in the single-entry and/or multi-entry PHR MAC CE, and R bits are present at the corresponding fields in each example MAC CE described above.

In some embodiments, the Enhanced Single Entry PHR for multiple TRP STxMP MAC CE and/or the Enhanced Multiple Entry PHR for multiple TRP STxMP MAC CE may be applied when twoPHRmode is configured for a MAC entity and multi-DCI STxMP operation is configured for at least one serving cell to be reported.

In some embodiments, if the MAC entity has UL resources allocated for a new transmission the MAC entity may perform the following operations:
1> if it is the first UL resource allocated for a new transmission since the last MAC reset:
2> start phr-PeriodicTimer.
1> if the Power Headroom reporting procedure determines that at least one PHR has been triggered and not cancelled; and
1> if the allocated UL resources can accommodate the MAC CE for PHR which the MAC entity is configured to transmit, plus its subheader, as a result of LCP:
2> if multiplePHR with value true is configured:
   3> for each activated Serving Cell with configured uplink associated with any MAC entity of which the active DL BWP is not dormant BWP; and
3> for each activated Serving Cell with configured uplink associated with E-UTRA MAC entity:
   4> if this MAC entity is configured with twoPHRMode:
      5> if this Serving Cell is configured with multipanelSchemeSDM or multipanelSchemeSFN or multiple TRP PUSCH repetition and the MAC entity this Serving Cell belongs to is configured with twoPHRMode:
         6> obtain two values of the Type 1 power headroom for the corresponding uplink carrier for NR Serving Cell.
      5> else:
         6> obtain the value of the Type 1 or Type 3 power headroom for the corresponding uplink carrier for NR Serving Cell and for E-UTRA Serving Cell.
4> else (i.e. this MAC entity is not configured with twoPHRMode):
   5> if this Serving Cell is configured with multiple TRP PUSCH repetition and if the MAC entity this Serving Cell belongs to is configured with twoPHRMode:
      6> if there is at least one real PUSCH transmission at the slot where the PHR MAC CE is transmitted:
         7> obtain the value of the Type 1 power headroom of the first real transmission of the corresponding uplink carrier for NR Serving Cell.
      6> else if there is no real PUSCH transmission at the slot where the PHR MAC CE is transmitted:
         7> obtain the value of the type 1 power headroom of the reference PUSCH transmission associated with the SRS-ResourceSet with a lower SRS-resourceSetID or the value of the type 3 power headroom for the corresponding uplink carrier for NR Serving Cell.
      5> else:
         6> obtain the value of the Type 1 or Type 3 power headroom for the corresponding uplink carrier for NR Serving Cell and for E-UTRA Serving Cell.
   4> if this MAC entity has UL resources allocated for transmission on this Serving Cell; or
   4> if the other MAC entity, if configured, has UL resources allocated for transmission on this Serving Cell and phr-ModeOtherCG is set to real by upper layers:
      5> if this MAC entity is configured with phr-AssumedPUSCH-Reporting:
         6> if dynamicTransformPrecoderFieldPresenceDCI-0-1-r18 or dynamicTransformPrecoderFieldPresenceDCI-0-2-r18 is set to enabled in the active BWP of this Serving Cell:
         7> obtain the value for the corresponding P_{CMAX,f,c} field for assumed PUSCH from the physical layer, if available.
      5> if this MAC entity is configured with twoPHRMode and if this Serving Cell is configured with multipanelSchemeSDM or multipanelSchemeSFN:
         6> obtain two values for the corresponding P_{CMAX,f,c,k} fields from the physical layer.
         6> if mpe-Reporting-FR2 is configured and this Serving Cell operates on FR2 and this Serving Cell is associated to this MAC entity:
         7> obtain two values for the corresponding MPEₖ fields from the physical layer.
      5> else:
         6> obtain the value for the corresponding P_{CMAX,f,c} field from the physical layer.
         6> if mpe-Reporting-FR2 is configured and this Serving Cell operates on FR2 and this Serving Cell is associated to this MAC entity:
         7> obtain the value for the corresponding MPE field from the physical layer.
      6> if mpe-Reporting-FR2-r17 is configured and this Serving Cell operates on FR2 and this Serving Cell is associated to this MAC entity:
         7> obtain the value for the corresponding MPEᵢ field from the physical layer;
         7> obtain the value for the corresponding Resourcei field from the physical layer.
      6> if dpc-Reporting-FR1 is configured and ΔP_{PowerClass}/ΔP_{PowerClass, CA}/ΔP_{PowerClass, EN-DC}/ΔP_{PowerClass, NR-DC} reporting is triggered and this Serving Cell operates on FR1 and this Serving Cell is associated to this MAC entity:
         7> obtain the value for the corresponding DPC field(s) from the physical layer.
   3> if phr-Type2OtherCell with value true is configured:
      4> if the other MAC entity is E-UTRA MAC entity:
         5> obtain the value of the Type 2 power headroom for the SpCell of the other MAC entity (i.e. E-UTRA MAC entity);
         5> ifphr-ModeOtherCG is set to real by upper layers:
         6> obtain the value for the corresponding P_{CMAX,f,c} field for the SpCell of the other MAC entity (i.e. E-UTRA MAC entity) from the physical layer.
   3> if this MAC entity is configured with mpe-Reporting-FR2-r17:
      4> instruct the Multiplexing and Assembly procedure to generate and transmit the Enhanced Multiple entry PHR based on the values reported by the physical layer.
      3> else if this MAC entity is configured with twoPHRMode and any associated Serving Cell is configured with multipanelSchemeSDM or multipanelSchemeSFN:
         4> instruct the Multiplexing and Assembly procedure to generate and transmit the Enhanced Multiple Entry PHR for multiple TRP STx2P MAC CE based on the values reported by the physical layer.
      3> else if this MAC entity is configured with twoPHRMode and any associated Serving Cell is configured with multiple TRP PUSCH repetition:
         4> instruct the Multiplexing and Assembly procedure to generate and transmit the Enhanced Multiple Entry PHR for multiple TRP MAC CE based on the values reported by the physical layer.
      3> else if this MAC entity is configured with phr-AssumedPUSCH-Reporting:
         4> instruct the Multiplexing and Assembly procedure to generate and transmit the Multiple Entry PHR with assumed PUSCH MAC CE based on the values reported by the physical layer.
      3> else:
         4> instruct the Multiplexing and Assembly procedure to generate and transmit the Multiple Entry PHR MAC CE based on the values reported by the physical layer.
   2> else (i.e. Single Entry PHR format is used):
      3> if this MAC entity is configured with twoPHRMode for multiple TRP PUSCH repetition or multipanelSchemeSDM or multipanelSchemeSFN:
         4> obtain two values of the Type 1 power headroom from the physical layer for the corresponding uplink carrier of the PCell.
      3> else:
         4> obtain the value of the Type 1 power headroom from the physical layer for the corresponding uplink carrier of the PCell.
   3> if this MAC entity is configured with phr-AssumedPUSCH-Reporting:
      4> if dynamicTransformPrecoderFieldPresenceDCI-0-1-r18 or dynamicTransformPrecoderFieldPresenceDCI-0-2-r18 is set to enabled in the active BWP of this Serving Cell:
         5> obtain the value for the corresponding P_{CMAX,f,c} field for assumed PUSCH from the physical layer, if available.
      3> if this MAC entity is configured with twoPHRMode and if this Serving Cell is configured with multipanelSchemeSDM or multipanelSchemeSFN:
      4> obtain two values for the corresponding P_{CMAX,f,c,k} fields from the physical layer.
      4> if mpe-Reporting-FR2 is configured and this Serving Cell operates on FR2 and this Serving Cell is associated to this MAC entity:
         5> obtain two values for the corresponding MPEₖ fields from the physical layer.
3> else:
   4> obtain the value for the corresponding P_{CMAX,f,c} field from the physical layer;
   4> if mpe-Reporting-FR2 is configured and this Serving Cell operates on FR2:
      5> obtain the value for the corresponding MPE field from the physical layer.
   4> if mpe-Reporting-FR2-r17 is configured and this Serving Cell operates on FR2 and this Serving Cell is associated to this MAC entity:
      5> obtain the value for the corresponding MPEᵢ field from the physical layer;
      5> obtain the value for the corresponding Resourcei field from the physical layer.
   4> if dpc-Reporting-FR1 is configured and this Serving Cell operates on FR1:
      5> obtain the value for the corresponding DPC field from the physical layer.
3> if this MAC entity is configured with mpe-Reporting-FR2-r17:
   4> instruct the Multiplexing and Assembly procedure to generate and transmit the Enhanced Single entry PHR based on the values reported by the physical layer.
3> else if this MAC entity is configured with twoPHRMode and this Serving Cell is configured with multipanelSchemeSDM or multipanelSchemeSFN:
   4> instruct the Multiplexing and Assembly procedure to generate and transmit the Enhanced Single Entry PHR for multiple TRP STx2P MAC CE based on the values reported by the physical layer.
3> else if this MAC entity is configured with twoPHRMode and this Serving Cell is configured with multiple TRP PUSCH repetition:
   4> instruct the Multiplexing and Assembly procedure to generate and transmit the Enhanced Single Entry PHR for multiple TRP MAC CE based on the values reported by the physical layer.
3> else if this MAC entity is configured with phr-AssumedPUSCH-Reporting:
   4> instruct the Multiplexing and Assembly procedure to generate and transmit the Single Entry PHR with assumed PUSCH MAC CE based on the values reported by the physical layer.
3> else:
   4> instruct the Multiplexing and Assembly procedure to generate and transmit the Single Entry PHR MAC CE based on the values reported by the physical layer.
2> if this PHR report is an MPE P-MPR report:
   3> start or restart the mpe-ProhibitTimer;
   3> cancel triggered MPE P-MPR reporting for Serving Cells included in the PHR MAC CE.
2> start or restart phr-Periodic Timer;
2> start or restart phr-ProhibitTimer;
2> cancel all triggered PHR(s).

All triggered PHRs may be cancelled when there is an ongoing SDT procedure and the UL grant(s) can accommodate all pending data available for transmission but is not sufficient to additionally accommodate the PHR MAC CE plus its subheader.

The Enhanced Multiple Entry PHR for multiple TRP STx2P MAC CE is identified by a MAC subheader with eLCID as Table 1.

The Enhanced Multiple Entry PHR for multiple TRP STx2P MAC CE has a variable size, and includes the bitmaps, a Type 2 PH field and an octet containing the associated P_{CMAX,f,c} field (if reported) for SpCell of the other MAC entity, a Type 1 PH field and an octet containing the associated P_{CMAX,f,c,k} field (if reported) for the PCell. It further includes, in ascending order based on the ServCellIndex, one or multiple of Type X PH fields and octets containing the associated P_{CMAX,f,c,k} fields (if reported) for Serving Cells other than PCell indicated in the bitmap for indicating the presence of PH(s).

The presence of Type 2 PH field for SpCell of the other MAC entity is configured by phr-Type2OtherCell with value true.

A single octet bitmap is used for indicating the presence of PH(s) per Serving Cell when the highest ServCellIndex of Serving Cell with configured uplink is less than 8, otherwise four octets are used.

The MAC entity determines whether PH value for an activated Serving Cell is based on real transmission or a reference format by considering the configured grant(s) and downlink control information which has been received until and including the PDCCH occasion in which the first UL grant for a new transmission that can accommodate the MAC CE for PHR as a result of LCP is received since a PHR has been triggered if the PHR MAC CE is reported on an uplink grant received on the PDCCH or until the first uplink symbol of PUSCH transmission minus PUSCH preparation time if the PHR MAC CE is reported on a configured grant.

For a band combination in which the UE does not support dynamic power sharing, the UE may omit the octets containing Power Headroom field and P_{CMAX,f,c,k} field for Serving Cells in the other MAC entity except for the PCell in the other MAC entity and the reported values of Power Headroom and P_{CMAX,f,c} for the PCell are up to UE implementation.

The two PHs together with two P_{CMAX,f,c,k} for the Serving Cell configured with multipanelSchemeSDM or multipanelSchemeSFN are reported if the MAC entity is configured with twoPHRMode.

The Enhanced Multiple Entry PHR for multiple TRP STx2P MAC CEs may include following fields:
Cᵢ: This field indicates the presence of PH field(s) for the Serving Cell with ServCellIndex i. The Cᵢ field set to 1 indicates that PH field(s) for the Serving Cell with ServCellIndex i is reported. The Cᵢ field set to 0 indicates that a PH field for the Serving Cell with ServCellIndex i is not reported;
Bᵢ: This field indicates whether one or two PH fields are present for the Serving Cell with ServCellIndex i if Cᵢ field is set to 1. The B₁ field set to 1 indicates that two PH fields for are present. The Bᵢ field set to 0 indicates that one PH field for the Serving Cell with ServCellIndex i is present. If C₁ field is set to 0, R bit is present instead.
BWP IDᵢ: This field indicates a UL BWP of the Serving Cell with ServCellIndex i for which the PH field(s) is reported if Cᵢ field is set to 1. If Cᵢ field set to 0, R bits are present instead.
R: Reserved bit, set to 0;
Vₖ: This field indicates if the PH k value is based on a real transmission or a reference format for k=1, 2. For Type 1 PH, the Vₖ field set to 0 indicates real transmission on PUSCH and the Vₖ field set to 1 indicates that a PUSCH reference format is used. For Type 2 PH, the Vₖ field set to 0 indicates real transmission on PUCCH and the Vₖ field set to 1 indicates that a PUCCH reference format is used. For Type 3 PH, the Vₖ field set to 0 indicates real transmission on SRS and the Vₖ field set to 1 indicates that an SRS reference format is used. Furthermore, for Type 2, and Type 3 PH, the Vₖ field set to 0 indicates the presence of the octet containing the associated P_{CMAX,f,c,k} field and the MPEₖ field;
Power Headroom k (PH k): This field indicates the power headroom level. For PHR with twoPHRmode, if the Serving cell is configured with multipanelSchemeSFN or multipanelSchemeSDM, PH 1 is associated with the first TCI-State or TCI-UL-State for a real or reference PUSCH transmission and PH 2 is associated with the second TCI-State or TCI-UL-State for a real or reference PUSCH transmission; if the Serving cell is configured with multiple TRP PUSCH repetition, PH 1 is associated with the SRS-ResourceSet with a lower srs-ResourceSetld and PH 2 is associated with the SRS-ResourceSet with a higher srs-ResourceSetld. PH fields for a Serving Cell are included in ascending order based on k. The length of the field is 6 bits. The reported PH, the corresponding power headroom levels, and the corresponding measured values for the NR Serving Cell while the corresponding measured values in dB for the E-UTRA Serving Cell may be predetermined;
Pₖ: If mpe-Reporting-FR2 is configured and the Serving Cell operates on FR2, the MAC entity may set this field to 0 if the applied P-MPR value associated with P_{CMAX,f,c,k}, to meet MPE requirements is less than P-MPR_00. Otherwise, it is set to 1. If mpe-Reporting-FR2 is not configured or the Serving Cell operates on FR1, this field indicates whether power backoff is applied due to power management. The MAC entity may set the Pₖ field to 1 if the corresponding P_{CMAX,f,c,k} field would have had a different value if no power backoff due to power management had been applied;
P_{CMAX,f,c,k}: If present, this field indicates the configured transmitted power P_{CMAX,f,c,k} for the NR Serving Cell and the P_{CMAX,c} or \tilde{P}_{CMAX,c} for the E-UTRA Serving Cell used for calculation of the preceding PH k field. The reported P_{CMAX,f,c,k} and the corresponding nominal UE transmit power levels, the corresponding measured values in dBm for the NR Serving Cell, and the corresponding measured values in dBm for the E-UTRA Serving Cell may be predetermined;
MPEₖ: If mpe-Reporting-FR2 is configured, and the Serving Cell operates on FR2, and if the Pₖ field is set to 1, this field indicates the applied power backoff to meet MPE requirements. The length of the field is 2 bits. If mpe-Reporting-FR2 is not configured, or if the Serving Cell operates on FR1, or if the Pₖ field is set to 0, R bits are present instead.

Examples of Enhanced Multiple Entry PHR for multiple TRP STx2P MAC CEs are as follows.

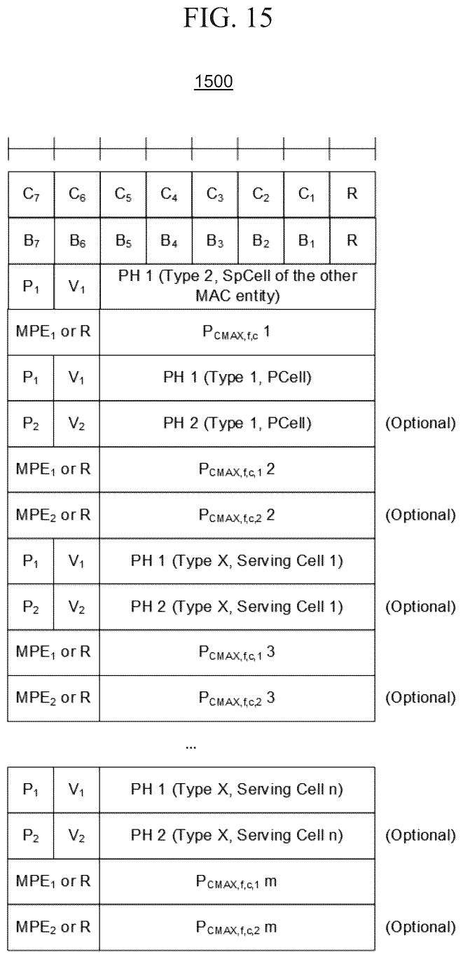

FIG. 15 shows an Enhanced Multiple Entry PHR for multiple TRP STx2P MAC CE 1500 with the highest ServCellIndex of Serving Cell with configured uplink is less than 8.

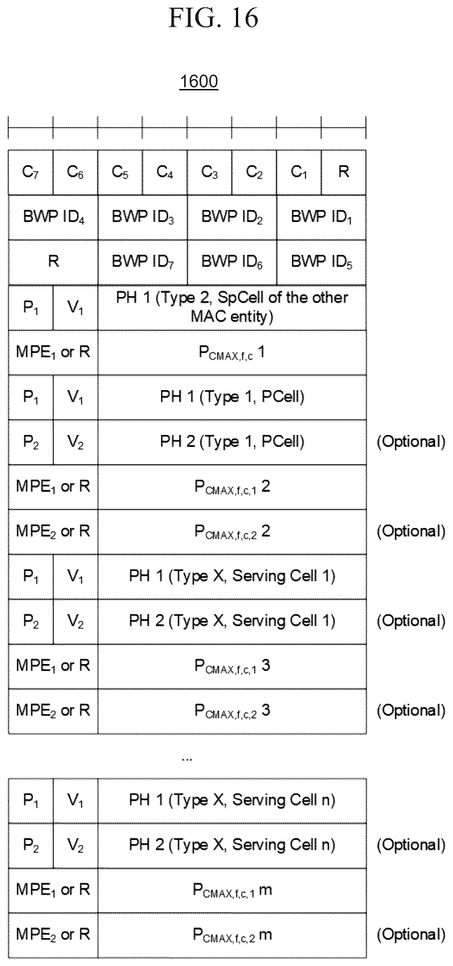

FIG. 16 shows an Enhanced Multiple Entry PHR for multiple TRP STx2P MAC CE 1600 with the highest ServCellIndex of Serving Cell with configured uplink is less than 8.

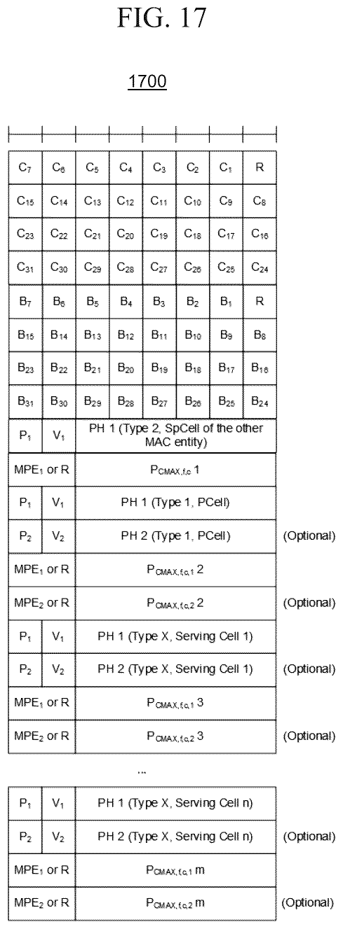

FIG. 17 shows an Enhanced Multiple Entry PHR for multiple TRP STx2P MAC CE 1700 with the highest ServCellIndex of Serving Cell with configured uplink is equal to or higher than 8.

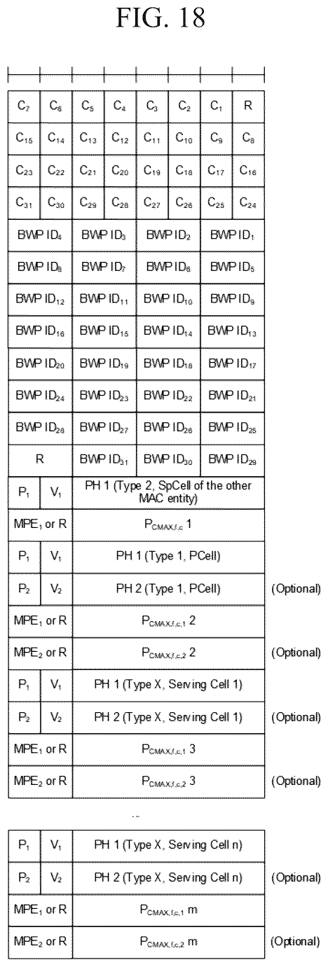

FIG. 18 shows an Enhanced Multiple Entry PHR for multiple TRP STx2P MAC CE 1800 with the highest ServCellIndex of Serving Cell with configured uplink is equal to or higher than 8.

The per BWP configuration for PUSCH repetition and/or multiPanelSchemeSFN and/or multiPanelSchemeSDM for each serving cell may be included in inter-node RRC message between MN and SN. In an embodiment, the per BWP configuration indicates a choice among PUSCH repetition, multiPanelSchemeSFN, multiPanelSchemeSDM, and none of the three for each BWP of each serving cell.

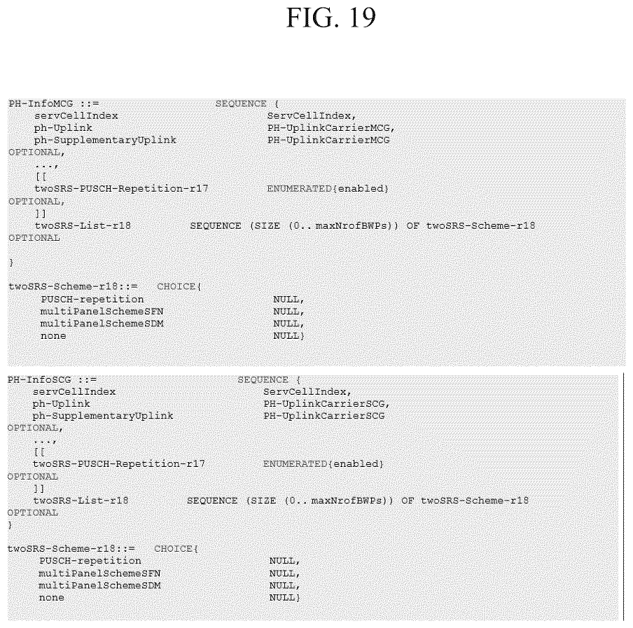

FIG. 19 shows an example per BWP configuration in accordance with an embodiment.

In FIG. 19, the twoSRS-List may indicates whether the indicated BWP of the indicated serving cell is configured for PUSCH repetition or multiPanelSchemeSFN or multiPanelSchemeSDM or none of the three corresponding to two SRS resource sets configured in either srs-ResourceSetToAddModList or srs-ResourceSetToAddModListDCI-0-2 with usage ‘codebook’ or ‘noncodebook’.

In some embodiments, when at least one PHR is triggered and not cancelled and if the allocated UL resources can accommodate the MAC CE for PHR and its subheader which the MAC entity is configured to transmit, if multiplePHR with value true is configured, if the MAC entity of the UE is configured with twoPHRmode and multipanelScheme is configured for at least a serving cell belonging to any MAC entity, UE can generate and send an Enhanced multi-entry PHR for Multi-TRP STxMP MAC CE to the BS.

The Enhanced Multiple Entry PHR for multiple TRP STx2P MAC CE is identified by a MAC subheader with eLCID as specified in Table 1.

The Enhanced Multiple Entry PHR for multiple TRP STx2P MAC CE has a variable size, and includes the bitmaps, a Type 2 PH field and an octet containing the associated P_{CMAX,f,c} field (if reported) for SpCell of the other MAC entity, a Type 1 PH field and an octet containing the associated P_{CMAX,f,c,k} field (if reported) for the PCell. Additionally, the MAC CE includes, in ascending order based on the ServCellIndex, one or multiple of Type X PH fields and octets containing the associated P_{CMAX,f,c,k} fields (if reported) for Serving Cells other than PCell indicated in the bitmap for indicating the presence of PH(s).

The presence of Type 2 PH field for SpCell of the other MAC entity is configured by phr-Type2OtherCell with value true.

A 2-octet bitmap is used for indicating the number of octets per Serving Cell when the highest ServCellIndex of Serving Cell with configured uplink is less than 8, otherwise eight octets are used.

The MAC entity determines whether PH value for an activated Serving Cell is based on real transmission or a reference format by considering the configured grant(s) and downlink control information which has been received until and including the PDCCH occasion in which the first UL grant for a new transmission that can accommodate the MAC CE for PHR as a result of LCP is received since a PHR has been triggered if the PHR MAC CE is reported on an uplink grant received on the PDCCH or until the first uplink symbol of PUSCH transmission minus PUSCH preparation time if the PHR MAC CE is reported on a configured grant.

For a band combination in which the UE does not support dynamic power sharing, the UE may omit the octets containing Power Headroom field and P_{CMAX,f,c,k} field for Serving Cells in the other MAC entity except for the PCell in the other MAC entity and the reported values of Power Headroom and P_{CMAX,f,c} for the PCell are up to UE implementation.

The two PHs together with two P_{CMAX,f,c,k} for the Serving Cell configured with multipanelSchemeSDM or multipanelSchemeSFN are reported if the MAC entity is configured with twoPHRMode.

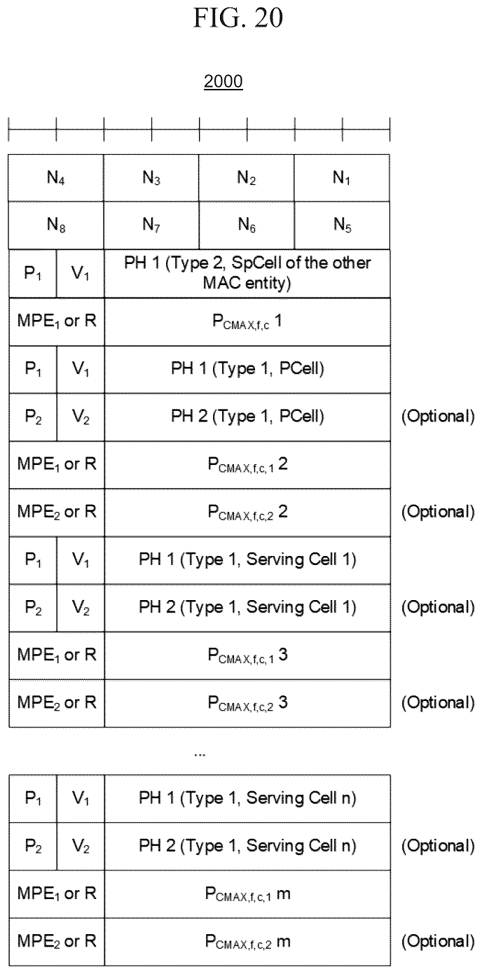

FIG. 20 shows an example Enhanced Multiple Entry PHR for multiple TRP STx2P MAC CE 2000 with the highest ServCellIndex of Serving Cell with configured uplink is less than 8 in accordance with an embodiment.

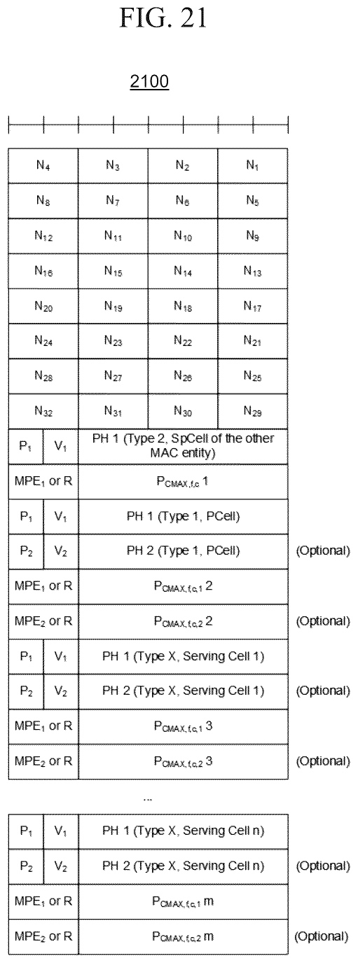

FIG. 21 shows an example Enhanced Multiple Entry PHR for multiple TRP STx2P MAC CE 2100 with the highest ServCellIndex of Serving Cell with configured uplink is equal to or higher than 8 in accordance with an embodiment.

The Enhanced Multiple Entry PHR for multiple TRP STx2P MAC CEs depicted in FIGS. 20 and 21 includes the following fields:
Nᵢ: This field with 2-bit length indicates the number of octets included in this MAC CE for each cell. The PCell and Serving Cells are indexed by i sequentially starting with PCell and followed by other Serving Cells in ascending order of ServCellIndex. The Nᵢ field set to 0 indicates no report for cell i. The Nᵢ field set to 1 indicates that an octet containing a PH field and an octet containing a configured transmitted power field are reported for cell i. The Nᵢ field set to 2 indicates that two octets containing PH fields and an octet containing a configured transmitted power field are reported for cell i. The Nᵢ field set to 3 indicates that two octets containing PH fields and two octets containing configured transmitted power fields are reported for cell i.
R: Reserved bit, set to 0;
Vₖ: This field indicates if the PH k value is based on a real transmission or a reference format for k=1, 2. For Type 1 PH, the Vₖ field set to 0 indicates real transmission on PUSCH and the Vₖ field set to 1 indicates that a PUSCH reference format is used. For Type 2 PH, the Vₖ field set to 0 indicates real transmission on PUCCH and the Vₖ field set to 1 indicates that a PUCCH reference format is used. For Type 3 PH, the Vₖ field set to 0 indicates real transmission on SRS and the Vₖ field set to 1 indicates that an SRS reference format is used. Furthermore, for Type 2, and Type 3 PH, the Vₖ field set to 0 indicates the presence of the octet containing the associated P_{CMAX,f,c,k} field and the MPEₖ field;
Power Headroom k (PH k): This field indicates the power headroom level. For PHR with twoPHRmode, if the Serving cell is configured with multipanelSchemeSFN or multipanelSchemeSDM, PH 1 is associated with the first TCI-State or TCI-UL-State for a real or reference PUSCH transmission and PH 2 is associated with the second TCI-State or TCI-UL-State for a real or reference PUSCH transmission; if the Serving cell is configured with multiple TRP PUSCH repetition, PH 1 is associated with the SRS-ResourceSet with a lower srs-ResourceSetld and PH 2 is associated with the SRS-ResourceSet with a higher srs-ResourceSetld. PH fields for a Serving Cell are included in ascending order based on k. The length of the field is 6 bits;
Pₖ: If mpe-Reporting-FR2 is configured and the Serving Cell operates on FR2, the MAC entity may set this field to 0 if the applied P-MPR value associated with P_{CMAX,f,c,k}, to meet MPE requirements is less than P-MPR_00. Otherwise, it is set to 1. If mpe-Reporting-FR2 is not configured or the Serving Cell operates on FR1, this field indicates whether power backoff is applied due to power management. The MAC entity may set the Pₖ field to 1 if the corresponding P_{CMAX,f,c,k} field would have had a different value if no power backoff due to power management had been applied;
P_{CMAX,f,c,k}: If present, this field indicates the configured transmitted power P_{CMAX,f,c,k} for the NR Serving Cell and the P_{CMAX,c} or \tilde{P}_{CMAX,c} for the E-UTRA Serving Cell used for calculation of the preceding PH k field. The reported P_{CMAX,f,c,k} and the corresponding nominal UE transmit power levels, the corresponding measured values, and the corresponding measured values may be predetermined;
MPEₖ: If mpe-Reporting-FR2 is configured, and the Serving Cell operates on FR2, and if the Pₖ field is set to 1, this field indicates the applied power backoff to meet MPE requirements. The length of the field is 2 bits. If mpe-Reporting-FR2 is not configured, or if the Serving Cell operates on FR1, or if the Pₖ field is set to 0, R bits are present instead.

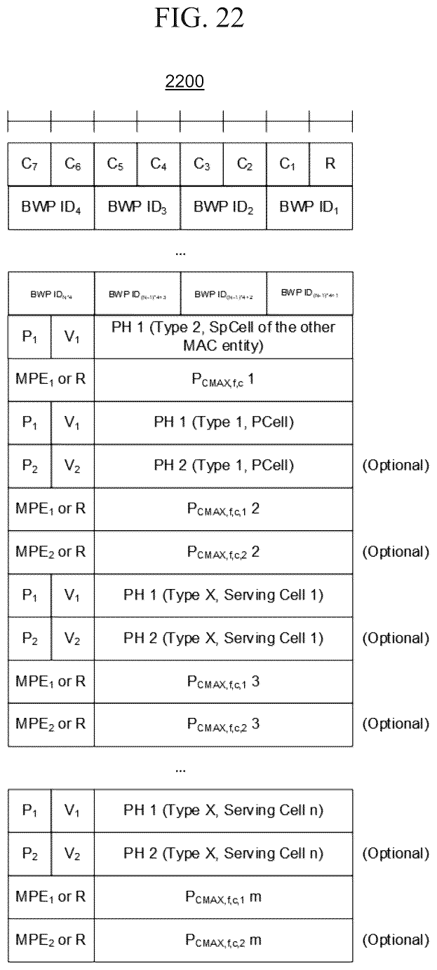

FIG. 22 shows an example Enhanced Multiple Entry PHR for multiple TRP STx2P MAC CE 2200 with BWP ID and the highest ServCellIndex of Serving Cell with configured uplink is less than 8 in accordance with an embodiment.

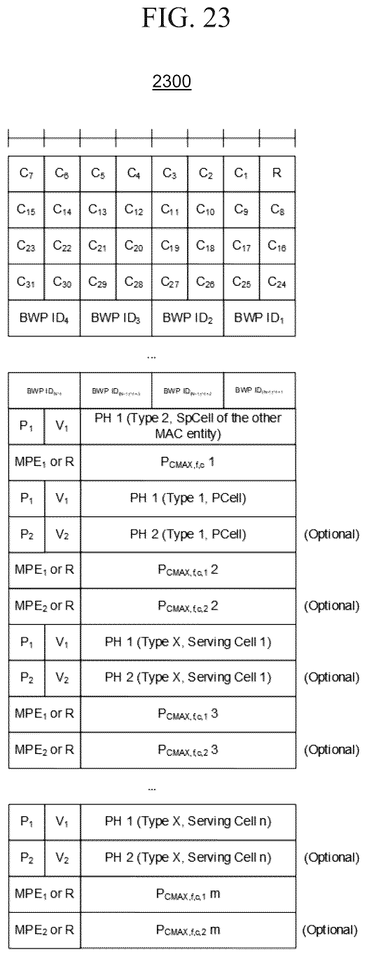

FIG. 23 shows an example Enhanced Multiple Entry PHR for multiple TRP STx2P MAC CE 2300 with BWP ID and the highest ServCelllndex of Serving Cell with configured uplink is equal to or higher than 8 in accordance with an embodiment.

In the examples of FIGS. 22 and 23, a single octet bitmap is used for indicating the presence of PH(s) per Serving Cell when the highest ServCellIndex of Serving Cell with configured uplink is less than 8, otherwise four octets are used. The Enhanced Multiple Entry PHR for multiple TRP STx2P MAC CEs includes the following fields:
Cᵢ: This field indicates the presence of PH field(s) for the Serving Cell with ServCellIndex i. The Cᵢ field set to 1 indicates that PH field(s) for the Serving Cell with ServCellIndex i is reported. The Cᵢ field set to 0 indicates that a PH field for the Serving Cell with ServCellIndex i is not reported;
BWP IDⱼ: This field indicates a UL BWP as the codepoint of the DCI bandwidth part indicator field, for the PCell and Serving Cells for which Cᵢ bit is set to 1. The PCell and Serving Cells for which Cᵢ bit is set to 1 are indexed sequentially starting with PCell and followed by other Serving Cells in ascending order of with ServCellIndex i for which the PH field(s) is reported if Cᵢ field is set to 1. N octets for BWP IDs is included in MAC CE if total number of Serving Cells (i.e. Serving Cells for which Cᵢ field is set to 1 and PCell) is greater than (N−1)*4 and less than N*4+1, where N=1, 2 for single-octet Cᵢ field, and N=1, 2, 3 . . . 8 for four-octet Cᵢ field. R bits are presents for the remaining bits to complete the last octet containing BWP IDⱼ.
R: Reserved bit, set to 0;
Vₖ: This field indicates if the PH k value is based on a real transmission or a reference format for k=1, 2. For Type 1 PH, the Vₖ field set to 0 indicates real transmission on PUSCH and the Vₖ field set to 1 indicates that a PUSCH reference format is used. For Type 2 PH, the Vₖ field set to 0 indicates real transmission on PUCCH and the Vₖ field set to 1 indicates that a PUCCH reference format is used. For Type 3 PH, the Vₖ field set to 0 indicates real transmission on SRS and the Vₖ field set to 1 indicates that an SRS reference format is used. Furthermore, for Type 2, and Type 3 PH, the Vₖ field set to 0 indicates the presence of the octet containing the associated P_{CMAX,f,c,k} field and the MPEₖ field;
Power Headroom k (PH k): This field indicates the power headroom level. For PHR with twoPHRmode, if the Serving cell is configured with multipanelSchemeSFN or multipanelSchemeSDM, PH 1 is associated with the first TCI-State or TCI-UL-State for a real or reference PUSCH transmission and PH 2 is associated with the second TCI-State or TCI-UL-State for a real or reference PUSCH transmission; if the Serving cell is configured with multiple TRP PUSCH repetition, PH 1 is associated with the SRS-ResourceSet with a lower srs-ResourceSetld and PH 2 is associated with the SRS-ResourceSet with a higher srs-ResourceSetld. PH fields for a Serving Cell are included in ascending order based on k. The length of the field is 6 bits;
Pₖ: If mpe-Reporting-FR2 is configured and the Serving Cell operates on FR2, the MAC entity may set this field to 0 if the applied P-MPR value associated with P_{CMAX,f,c,k}, to meet MPE requirements is less than P-MPR_00 and to 1 otherwise. If mpe-Reporting-FR2 is not configured or the Serving Cell operates on FR1, this field indicates whether power backoff is applied due to power management. The MAC entity may set the Pₖ field to 1 if the corresponding P_{CMAX,f,c,k} field would have had a different value if no power backoff due to power management had been applied;
P_{CMAX,f,c,k}: If present, this field indicates the configured transmitted power P_{CMAX,f,c,k} for the NR Serving Cell and the P_{CMAX,c} or \tilde{P}_{CMAX,c} for the E-UTRA Serving Cell used for calculation of the preceding PH k field.;
MPEₖ: If mpe-Reporting-FR2 is configured, and the Serving Cell operates on FR2, and if the Pₖ field is set to 1, this field indicates the applied power backoff to meet MPE requirements. The length of the field is 2 bits. If mpe-Reporting-FR2 is not configured, or if the Serving Cell operates on FR1, or if the Pₖ field is set to 0, R bits are present instead.

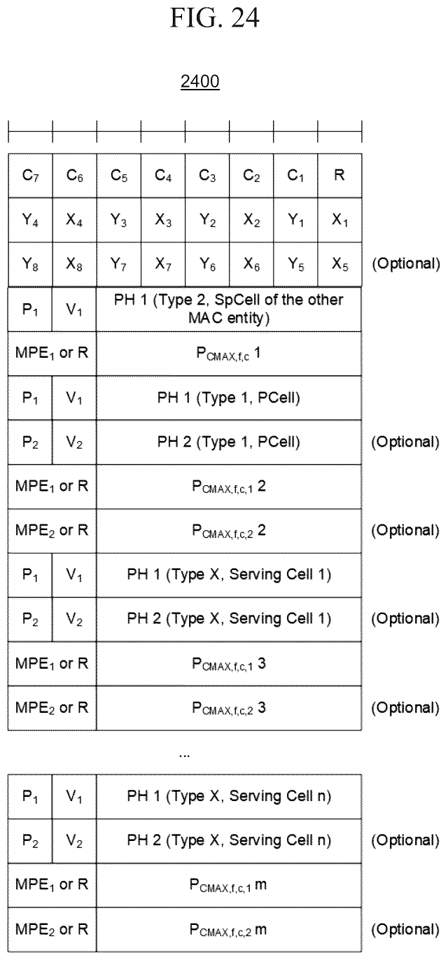

FIG. 24 shows an example Enhanced Multiple Entry PHR for multiple TRP STx2P MAC CE 2400 with fields bitmap and the highest ServCelllndex of Serving Cell with configured uplink is less than 8 in accordance with an embodiment.

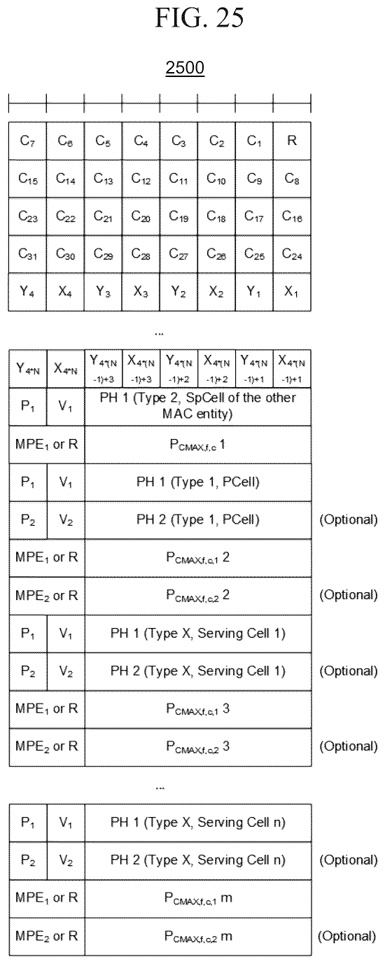

FIG. 25 shows an example Enhanced Multiple Entry PHR for multiple TRP STx2P MAC CE 2500 with fields bitmap and the highest ServCelllndex of Serving Cell with configured uplink is equal to or higher than 8 in accordance with an embodiment.

In examples of FIGS. 24 and 25, a single octet bitmap is used for indicating the presence of PH(s) per Serving Cell when the highest ServCellIndex of Serving Cell with configured uplink is less than 8, otherwise four octets are used. The Enhanced Multiple Entry PHR for multiple TRP STx2P MAC CEs may include the following fields:
Cᵢ: This field indicates the presence of PH field(s) for the Serving Cell with ServCelllndex i. The Cᵢ field set to 1 indicates that PH field(s) for the Serving Cell with ServCellIndex i is reported. The Cᵢ field set to 0 indicates that a PH field for the Serving Cell with ServCellIndex i is not reported;
Xⱼ: This field indicates whether the octet containing the second PH is present or not for the Serving Cell with Cᵢ field set to 1. The PCell and Serving Cells for which Cᵢ field is set to 1 are indexed sequentially starting with PCell and followed by other Serving Cells in ascending order of with ServCellIndex i for which the PH field(s) is reported if Cᵢ field is set to 1. This field set to 1 indicates the octet containing the second PH is present for the corresponding Serving Cell with Cᵢ field set to 1; this field set to 0 indicates the octet containing the second PH is absent for the corresponding Serving Cell with Cᵢ field set to 1.
Yⱼ: This field indicates whether the octet containing the second P_{CMAX,f,c,k} is present or not for the Serving Cell with Cᵢ field set to 1. The PCell and Serving Cells for which Cᵢ field is set to 1 are indexed sequentially starting with PCell and followed by other Serving Cells in ascending order of with ServCellIndex i for which the PH field(s) is reported if Cᵢ field is set to 1. This field set to 1 indicates the octet containing the second P_{CMAX,f,c,k} is present for the corresponding Serving Cell with Cᵢ field set to 1; this field set to 0 indicates the octet containing the second P_{CMAX,f,c,k} is absent for the corresponding Serving Cell with Cᵢ field set to 1.N octets for Xⱼ and Yⱼ are included in this MAC CE if the total number of Serving Cells (i.e. Serving Cells for which Cᵢ bit is set to 1 and PCell) is greater than 4*(N−1) and less than 4*N+1, where N=1, 2 for single-octet Cᵢ field, and N=1, 2, 3 . . . 8 for four-octet Cᵢ field. R bits are presents for the remaining bits in the last octet containing Xⱼ and Yⱼ.
R: Reserved bit, set to 0;
Vₖ: This field indicates if the PH k value is based on a real transmission or a reference format for k=1, 2. For Type 1 PH, the Vₖ field set to 0 indicates real transmission on PUSCH and the Vₖ field set to 1 indicates that a PUSCH reference format is used. For Type 2 PH, the Vₖ field set to 0 indicates real transmission on PUCCH and the Vₖ field set to 1 indicates that a PUCCH reference format is used. For Type 3 PH, the Vₖ field set to 0 indicates real transmission on SRS and the Vₖ field set to 1 indicates that an SRS reference format is used. Furthermore, for Type 2, and Type 3 PH, the Vₖ field set to 0 indicates the presence of the octet containing the associated P_{CMAX,f,c,k} field and the MPEₖ field;
Power Headroom k (PH k): This field indicates the power headroom level. For PHR with twoPHRmode, if the Serving cell is configured with multipanelSchemeSFN or multipanelSchemeSDM, PH 1 is associated with the first TCI-State or TCI-UL-State for a real or reference PUSCH transmission and PH 2 is associated with the second TCI-State or TCI-UL-State for a real or reference PUSCH transmission; if the Serving cell is configured with multiple TRP PUSCH repetition, PH 1 is associated with the SRS-ResourceSet with a lower srs-ResourceSetld and PH 2 is associated with the SRS-ResourceSet with a higher srs-ResourceSetld. PH fields for a Serving Cell are included in ascending order based on k. The length of the field is 6 bits;
Pₖ: If mpe-Reporting-FR2 is configured and the Serving Cell operates on FR2, the MAC entity may set this field to 0 if the applied P-MPR value associated with P_{CMAX,f,c,k}, to meet MPE requirements, as specified in TS 38.101-2 [15], is less than P-MPR_00 as specified in TS 38.133 [11] and to 1 otherwise. If mpe-Reporting-FR2 is not configured or the Serving Cell operates on FR1, this field indicates whether power backoff is applied due to power management. The MAC entity may set the Pₖ field to 1 if the corresponding P_{CMAX,f,c,k} field would have had a different value if no power backoff due to power management had been applied;
P_{CMAX,f,c,k}: If present, this field indicates the configured transmitted power P_{CMAX,f,c,k} for the NR Serving Cell and the P_{CMAX,c} or \tilde{P}_{CMAX,c} (as specified in TS 36.213 [17]) for the E-UTRA Serving Cell used for calculation of the preceding PH k field. The reported P_{CMAX,f,c,k} and the corresponding nominal UE transmit power levels, the corresponding measured values in dBm for the NR Serving Cell, and the corresponding measured values in dBm for the E-UTRA Serving Cell may be predetermined;
MPEₖ: If mpe-Reporting-FR2 is configured, and the Serving Cell operates on FR2, and if the Pₖ field is set to 1, this field indicates the applied power backoff to meet MPE requirements. The length of the field is 2 bits. If mpe-Reporting-FR2 is not configured, or if the Serving Cell operates on FR1, or if the Pₖ field is set to 0, R bits are present instead.

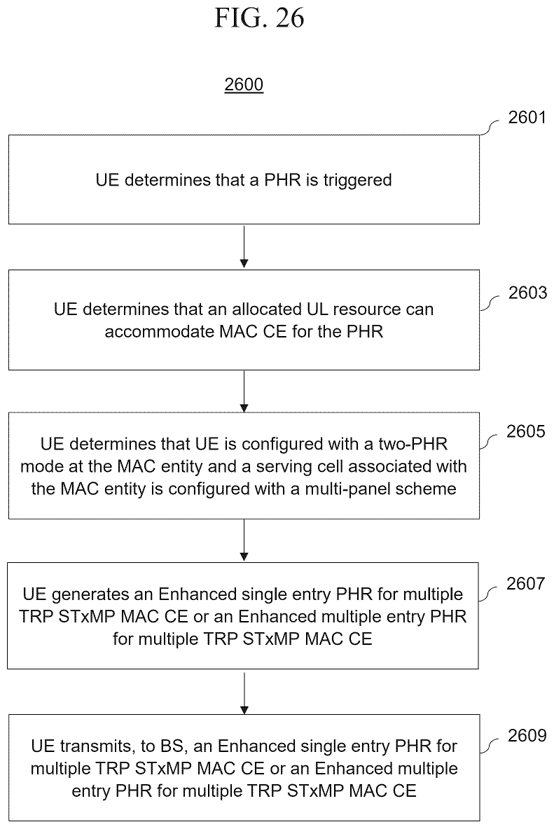

FIG. 26 shows an example process 2600 at UE for a power headroom reporting for multi-TRP STxMP operation in accordance with an embodiment. For explanatory and illustration purposes, the example process 2600 may be performed by a UE. Although one or more operations are described or shown in particular sequential order, in other embodiments the operations may be rearranged in a different order, which may include performance of multiple operations in at least partially overlapping time periods.

Referring to FIG. 26, the process 2600 may begin in operation 2601. In operation 2601, UE determines that a PHR is triggered.

In operation 2603, UE determines that an allocated UL resource is able to accommodate a MAC CE for the PHR.

In operation 2605, UE determines that UE is configured with a two-PHR mode for a MAC entity at UE and a serving cell associated with the MAC entity is configured with a multi-panel scheme.

In operation 2607, UE generates an enhanced single entry PHR for multiple TRP STxMP MAC CE or an enhanced multiple entry PHR for multiple TRP STxMP MAC CE.

In operation 2609, UE transmit, to a BS, the enhanced single entry PHR for multiple TRP STxMP MAC CE or the enhanced multiple entry PHR for multiple TRP STxMP MAC CE.

In some embodiments, UE generates the enhanced single entry PHR for multiple TRP STxMP MAC CE based on a determination that a single entry PHR is used.

In some embodiments, UE generates the enhanced multiple entry PHR for multiple TRP STxMP MAC CE based on a determination that multiple PHRs are configured.

In some embodiments, the enhanced single entry PHR for multiple TRP STxMP MAC CE includes two sets of fields, each set including a PH field and a configured transmitted power field. The PH field indicates a type-1 power headroom level, and the configured transmitted power field indicates a configured maximum output power that is used for calculation of a preceding PH field. In an embodiment, a first PH field in a first set of fields is associated with a first TCI state for a first PUSCH transmission, and a second PH field in a second set of fields is associated with a second TCI state for a second PUSCH transmission.

In some embodiments, each set further includes a field indicating whether a corresponding PH field is associated with a real PUSCH transmission or a reference PUSCH transmission.

In some embodiments, the enhanced multiple entry PHR for multiple TRP STxMP MAC CE includes two sets of fields for each reported serving cell that is configured with the multi-panel scheme. Each includes a PH field and a configured transmitted power field. The PH field indicates a type-1 power headroom level and the configured transmitted power field indicates a configured maximum output power that is used for calculation of a preceding PH field. In an embodiment, a first PH field in a first set of fields is associated with a first TCI state for a first PUSCH transmission, and a second PH field in a second set of fields is associated with a second TCI state for a second PUSCH transmission.

In some embodiments, each set further includes a field indicating whether a corresponding PH field is associated with a real PUSCH transmission or a reference PUSCH transmission.

In some embodiments, the each set further includes a maximum permissible exposure (MPE) information associated with a corresponding configured transmitted power field for the serving cell operating on FR 2.

In some embodiments, for the enhanced multiple entry PHR for multiple TRP STxMP MAC CE, UE obtains two type-1 PH values for a corresponding uplink carrier for the serving cell. Each type-1 PH value indicates a difference between a nominal UE maximum transmit power and an estimated power for an UL-SCH transmission.

In some embodiments, for the enhanced single entry PHR for multiple TRP STxMP MAC CE, UE obtains two type-1 PH values and two configured transmitted power values for a corresponding uplink carrier for a primary cell. Each type-1 PH value indicates a difference between a nominal UE maximum transmit power and an estimated power for a UL-SCH transmission.

According to various embodiments disclosed herein, detailed examples are provided of how UE performs PHR for single-DCI multi-TRP STxMP transmission. Additionally, the disclosure presents various embodiments for designing MAC CEs to report PH and the configured maximum transmission power for multiple serving cells.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) for facilitating communication in a wireless network, the UE comprising:
a processor configured to:
determine that a power headroom reporting (PHR) is triggered;
determine that an allocated uplink resource is able to accommodate a medium access control (MAC) control element (CE) for the PHR;
determine that the UE is configured with a two-PHR mode for a MAC entity and a serving cell associated with the MAC entity is configured with a multi-panel scheme; and
generate an enhanced single entry PHR for multiple transmit-receive point (TRP) simultaneous transmission with multi-panel (STxMP) MAC CE or an enhanced multiple entry PHR for multiple TRP STxMP MAC CE; and
a transceiver operably coupled with the processor, the transceiver configured to:
transmit, to a base station (BS), the enhanced single entry PHR for multiple TRP STxMP MAC CE or the enhanced multiple entry PHR for multiple TRP STxMP MAC CE.

2. The UE of claim 1, wherein the processor is configured to generate the enhanced single entry PHR for multiple TRP STxMP MAC CE based on a determination that a single entry PHR is used.

3. The UE of claim 1, wherein the processor is configured to generate the enhanced multiple entry PHR for multiple TRP STxMP MAC CE based on a determination that multiple PHRs are configured.

4. The UE of claim 2, wherein the enhanced single entry PHR for multiple TRP STxMP MAC CE includes two sets of fields, each set including a power headroom (PH) field and a configured transmitted power field,
where the PH field indicates a type-1 power headroom level, and the configured transmitted power field indicates a configured maximum output power that is used for calculation of a preceding PH field, and
wherein a first PH field in a first set of fields is associated with a first transmission configuration indicator (TCI) state for a first physical uplink shared channel (PUSCH) transmission, and a second PH field in a second set of fields is associated with a second TCI state for a second PUSCH transmission.

5. The UE of claim 4, wherein each set further includes a field indicating whether a corresponding PH field is associated with a real PUSCH transmission or a reference PUSCH transmission.

6. The UE of claim 3, wherein the enhanced multiple entry PHR for multiple TRP STxMP MAC CE includes two sets of fields for each reported serving cell that is configured with the multi-panel scheme, each set including a PH field and a configured transmitted power field,
where the PH field indicates a type-1 power headroom level and the configured transmitted power field indicates a configured maximum output power that is used for calculation of a preceding PH field, and
wherein a first PH field in a first set of fields is associated with a first TCI state for a first PUSCH transmission, and a second PH field in a second set of fields is associated with a second TCI state for a second PUSCH transmission.

7. The UE of claim 6, wherein each set further includes a field indicating whether a corresponding PH field is associated with a real PUSCH transmission or a reference PUSCH transmission.

8. The UE of claim 6, wherein the each set further includes a maximum permissible exposure (MPE) information associated with a corresponding configured transmitted power field for the serving cell operating on frequency range 2 (FR 2).

9. The UE of claim 1, wherein the processor is further configured, for the enhanced multiple entry PHR for multiple TRP STxMP MAC CE, to obtain two type-1 PH values for a corresponding uplink carrier for the serving cell, each type-1 PH value indicating a difference between a nominal UE maximum transmit power and an estimated power for an uplink shared channel (UL-SCH) transmission.

10. The UE of claim 1, wherein the processor is further configured, for the enhanced single entry PHR for multiple TRP STxMP MAC CE, to obtain two type-1 PH values and two a configured transmitted power values for a corresponding uplink carrier for a primary cell, each type-1 PH value indicating a difference between a nominal UE maximum transmit power and an estimated power for a UL-SCH transmission.

11. A method performed by a user equipment (UE) in a wireless network, the method comprising:
determining that a power headroom reporting (PHR) is triggered;
determining that an allocated uplink resource is able to accommodate a medium access control (MAC) control element (CE) for the PHR;
determining that the UE is configured with a two-PHR mode for a MAC entity and a serving cell associated with the MAC entity is configured with a multi-panel scheme;
generating an enhanced single entry PHR for multiple transmit-receive point (TRP) simultaneous transmission with multi-panel (STxMP) MAC CE or an enhanced multiple entry PHR for multiple TRP STxMP MAC CE; and
transmitting, to a base station (BS), the enhanced single entry PHR for multiple TRP STxMP MAC CE or the enhanced multiple entry PHR for multiple TRP STxMP MAC CE.

12. The method of claim 11, wherein the generating comprises generating the enhanced single entry PHR for multiple TRP STxMP MAC CE based on a determination that a single entry PHR is used.

13. The method of claim 11, wherein the generating comprises generating the enhanced multiple entry PHR for multiple TRP STxMP MAC CE based on a determination that multiple PHRs are configured.

14. The method of claim 12, wherein the enhanced single entry PHR for multiple TRP STxMP MAC CE includes two sets of fields, each set including a power headroom (PH) field and a configured transmitted power field,
where the PH field indicates a type-1 power headroom level, and the configured transmitted power field indicates a configured maximum output power that is used for calculation of a preceding PH field, and
wherein a first PH field in a first set of fields is associated with a first transmission configuration indicator (TCI) state for a first physical uplink shared channel (PUSCH) transmission, and a second PH field in a second set of fields is associated with a second TCI state for a second PUSCH transmission.

15. The method of claim 14, wherein each set further includes a field indicating whether a corresponding PH field is associated with a real PUSCH transmission or a reference PUSCH transmission.

16. The method of claim 13, wherein the enhanced multiple entry PHR for multiple TRP STxMP MAC CE includes two sets of fields for each reported serving cell that is configured with the multi-panel scheme, each set including a PH field and a configured transmitted power field,
where the PH field indicates a type-1 power headroom level and the configured transmitted power field indicates a configured maximum output power that is used for calculation of a preceding PH field, and
wherein a first PH field in a first set of fields is associated with a first TCI state for a first PUSCH transmission, and a second PH field in a second set of fields is associated with a second TCI state for a second PUSCH transmission.

17. The method of claim 16, wherein each set further includes a field indicating whether a corresponding PH field is associated with a real PUSCH transmission or a reference PUSCH transmission.

18. The method of claim 6, wherein the each set further includes a maximum permissible exposure (MPE) information associated with a corresponding configured transmitted power field for the serving cell operating on frequency range 2 (FR 2).

19. The method of claim 11, further comprising, for the enhanced multiple entry PHR for multiple TRP STxMP MAC CE, obtaining two type-1 PH values for a corresponding uplink carrier for the serving cell, each type-1 PH value indicating a difference between a nominal UE maximum transmit power and an estimated power for an uplink shared channel (UL-SCH) transmission.

20. The method of claim 11, further comprising, for the enhanced single entry PHR for multiple TRP STxMP MAC CE, obtaining two type-1 PH values and two configured transmitted power values for a corresponding uplink carrier for a primary cell, each type-1 PH value indicating a difference between a nominal UE maximum transmit power and an estimated power for a UL-SCH transmission.
